(19) United States
(12) Patent Application Publication
(10) Pub. No.: US 2012/0112991 A1
(43) Pub. Date: May 10, 2012

(54) LIQUID CRYSTAL DISPLAY DEVICE AND METHOD FOR CONTROLLING DISPLAY OF LIQUID CRYSTAL DISPLAY DEVICE

(75) Inventors: Katsuteru Hashimoto, Osaka (JP); Katsuya Otoi, Osaka (JP); Hideki Ichioka, Osaka (JP); Kohji Fujiwara, Osaka (JP)

(73) Assignee: SHARP KABUSHIKI KAISHA, Osaka-shi, Osaka (JP)

(21) Appl. No.: 13/382,009

(22) PCT Filed: Mar. 9, 2010
(86) PCT No.: PCT/JP2010/001654

§ 371 Date: Jan. 3, 2012

(30) Foreign Application Priority Data
Jul. 7, 2009 (JP) 2009-160871

(51) Int. Cl. G09G 3/36

(52) U.S. Cl. 345/89

(57) ABSTRACT

An embodiment of a liquid crystal display device includes: a liquid crystal panel including pixels arranged in a pixel; and a backlight that irradiates it with light. In at least one example embodiment, the pixels included in the liquid crystal panel each include picture elements different in color. The picture elements are each provided with a color filter corresponding to the color of the picture element. The liquid crystal display device includes: an aperture ratio converting section that, to reduce optical cross talk, decreases an aperture ratio for inputted image data and outputs data of the aperture ratio; and a backlight data converting section that, to supplement the aperture ratio for the image data which is decreased by the aperture ratio converting section, converts data to increase a backlight luminance. This backlight luminance control prevents or reduces optical or electrical cross talk.

### TECHNICAL FIELD

The present invention relates to a liquid crystal display device and a method for controlling display of a liquid crystal display device.

### BACKGROUND ART

In recent years, liquid crystal display devices, which have been replacing cathode ray tube (CRT) based display devices, are in widespread use. Liquid crystal display devices, which are characteristic in that they are, for example, energy-saving, thin, and lightweight, are widely used in, for example, flat-screen televisions, monitors, and mobile telephones. A liquid crystal display device typically includes an active matrix liquid crystal panel including thin film transistors (TFTs) as switching elements.

An active matrix liquid crystal panel includes (i) an active matrix substrate in which a large number of pixels are arranged in a matrix, (ii) a counter substrate provided so as to face the active matrix substrate, and (iii) a liquid crystal layer sandwiched between the above two substrates and serving as a display medium.

The pixels in the active matrix substrate include picture elements (sub-pixels) each having one of the three colors red (R), green (G), and blue (B). The counter substrate includes color filters for R, G, and B in correspondence with the picture elements having the three colors. The color filters having the three colors have, for example, spectral characteristics illustrated in FIG. 14 (see FIG. 13 of Patent Literature 2).

As illustrated in FIG. 14, the color filters having the three colors each have a peak transmittance in the vicinity of the wavelength of a corresponding one of R, G, and B, but also transmit light beams of wavelengths of other colors to a degree. The picture elements having the colors R, G, and B are provided with color filters having the above respective properties. This reduces color purity of display colors, for example, leads to a phenomenon of blue light leaking out of G picture elements.

The following assumes a case in which, for example, (i) the color filters have the properties illustrated in FIG. 14. (ii) expressing target gray scale values (that is, gray scales intended to be displayed) requires the luminances (R, G, B)=(100, 100, 30) as illustrated in FIG. 15, and (iii) the LCD has the aperture ratios (R, G, B)=(100, 100, 30) accordingly. In this case, since a light beam of the wavelength for blue tends to leak out of green color filters, blue light included in backlight irradiation light leaks out of the green color filters. This unfortunately results in actually expressed luminances of (R, G, B)=(100, 100, 45) as illustrated in FIG. 15. Such a phenomenon, called optical cross talk, causes a decrease in display quality.

Further, in an active matrix liquid crystal panel, in the case where there is a large difference in display gray scale between adjacent picture elements, a voltage applied to a first target picture element is changed by influence of a voltage applied to a second target picture element adjacent to the first target picture element. This unfortunately leads to a phenomenon of a display gray scale being shifted from its desired gray scale value. Such a phenomenon, called electrical cross talk, causes a decrease in display quality.

FIG. 16 illustrates an example of electrical cross talk. The following assumes a case in which, as illustrated in FIG. 16, (i) expressing target gray scale values requires the luminances (R, G, B)=(100, 100, 30) and (ii) the LCD has the aperture ratios (R, G, B)=(100, 100, 30) accordingly. The gray scale difference between a G picture element and a B picture element adjacent to each other causes a decrease in value of expressed gray scale for G. This unfortunately results in actually expressed luminances of (R, G, B)=(100, 85, 30) as illustrated in FIG. 16, and consequently in a decrease in display quality such as a color shift and a luminance decrease.

Patent Literature 1 discloses a method for carrying out color collection in a liquid crystal panel to correct optical cross talk such as the above. This method is carried out by the following circuits in a device: a color rotation circuit, an (R-Y) amplifier circuit, a (B-Y) amplifier circuit, and a color inversion circuit.

FIG. 17 illustrates an example of canceling optical cross talk by the method disclosed in Patent Literature 1. As illustrated in FIG. 17, in the case where expressing target gray scale values requires the luminances (R, G, B)=(100, 100, 30), the method predicts blue light leaking out of G picture elements in a liquid crystal panel (LCD), and thus converts the aperture ratios of the LCD from (R, G, B)=(100, 100, 30) to (R, G, B)=(100, 100, 15) to decrease transmittance of B picture elements.

Patent Literature 2 discloses a cross talk canceling circuit for canceling electrical cross talk and optical cross talk such as the above. This cross talk canceling circuit refers to a LUT that associates, with correction value data, each combination of (i) a display signal for a correction target picture element and (ii) a display signal for a picture element that is adjacent to the correction target picture element and that influences the correction target picture element to cause cross talk. The cross talk canceling circuit thus corrects an inputted display signal on the basis of correction value data from LUT data to cancel cross talk.

FIG. 18 illustrates an example of canceling electrical cross talk by the method disclosed in Patent Literature 2. As illustrated in FIG. 18, in the case where expressing target gray scale values requires the luminances (R, G, B)=(100, 100, 30), the method converts the aperture ratios of the LCD from (R, G, B)=(100, 100, 30) to (R, G, B)=(100, 115, 30) to increase transmittance of G picture elements in the liquid crystal panel (LCD).

### CITATION LIST

### Patent Literature 1

Japanese Patent Application Publication, Tokukai, No. 2000-333194 A (Publication Date: Nov. 30, 2000)

### Patent Literature 2

Japanese Patent Application Publication, Tokukai, No. 2006-23710 A (Publication Date: Jan. 26, 2006)

### Patent Literature 3

Japanese Patent Application Publication, Tokukai, No. 2004-212503 A (Publication Date: Jul. 29, 2004)

### SUMMARY OF INVENTION

### Technical Problem

The method of Patent Literature 1, however, intends to predict possible optical cross talk occurring due to the properties of the color filters of the respective colors and thus correct data. In other words, this method does not prevent or reduce optical cross talk itself. This method thus cannot easily carry out an appropriate correction to optical cross talk occurring due to a change that is caused in color filter property by a factor beyond prediction such as temperature. The method of Patent Literature 1 poses a further problem of a cost increase due to a large number of additional circuits.

The method of Patent Literature 2 intends to correct data with reference to a LUT created to predict the amount of cross talk that can occur due to a gray scale difference between adjacent picture elements. In other words, this method does not prevent or reduce electrical or optical cross talk itself. This method thus cannot easily carry out an appropriate correction to cross talk occurring due to a change that is caused in gray scale difference property by a factor beyond prediction such as temperature. The method of Patent Literature 2 poses a further problem of a cost increase due to the need to include a LUT in which each combination of gray scale values is associated with correction data.

The present invention has been accomplished in view of the above problems. It is an object of the present invention to reduce optical or electrical cross talk more effectively than conventional by controlling luminances in backlight.

### Solution to Problem

In order to solve the above problems, a liquid crystal display device of the present invention includes: a liquid crystal panel including pixels arranged in a matrix; and a backlight that irradiates the liquid crystal panel with light, the pixels each including a plurality of picture elements that are different from one another in color, the picture elements each being provided with a color filter corresponding to a color of the picture element, the liquid crystal display device further comprising: an aperture ratio converting section that, in order to reduce light which has a wavelength of a color different from the color of the picture element and which is transmitted through the color filter with which the picture element is provided, decreases an aperture ratio of a picture element, the aperture ratio being included in inputted image data, and outputs data of the decreased aperture ratio; and a backlight luminance control section that, in order to supplement the aperture ratio decreased by the aperture ratio converting section, increases a backlight luminance as compared to a case in which the aperture ratio is not decreased, the liquid crystal display device carrying out an intended gray scale display on a basis of (i) backlight luminances determined by the backlight luminance control section and (ii) aperture ratios of the respective picture elements in the liquid crystal panel, said aperture ratios having been obtained through an aperture ratio conversion process by the aperture ratio converting section.

The liquid crystal display device of the present invention includes: a liquid crystal panel including pixels arranged in a matrix; and a backlight that irradiates the liquid crystal panel with light. The pixels each include a plurality of picture elements that are different from each other in color. This means that one pixel is made up of picture elements having a plurality of colors. The picture elements, each serving as a part of a pixel, are called sub-pixels as well.

The liquid crystal display device of the present invention includes an aperture ratio converting section that, in order to reduce light which has a wavelength of a color different from the color of the picture element and which is transmitted through the color filter with which the picture element is provided, decreases an aperture ratio of a picture element for inputted image data and outputs data of the decreased aperture ratio. The aperture ratio converting section decreases an aperture ratio for inputted image data and outputs data of the aperture ratio, which has a value decreased from the inputted value. This arrangement reduces the amount of optical cross talk occurring due, for example, to light that is within a wavelength range of blue and that leaks out of a green color filter.

The liquid crystal display device of the present invention further includes a backlight luminance control section that increases a backlight luminance in order to compensate for a change in a display gray scale of each picture element which change is caused by the above aperture ratio conversion process. The liquid crystal display device carries out an intended gray scale display on the basis of (i) backlight luminances determined by the backlight luminance control section and (ii) aperture ratios of the respective picture elements in the liquid crystal panel, the aperture ratios having been obtained through the aperture ratio conversion process by the aperture ratio converting section.

In other words, the liquid crystal display device of the present invention causes the aperture ratio converting section to process image data, transmitted to the liquid crystal panel, so as to reduce the amount of optical cross talk, and changes a backlight luminance to compensate for a shift from an intended gray scale in image data which shift occurs due to the above aperture ratio conversion process.

The above arrangement prevents the occurrence of or reduces the amount of optical cross talk itself. The above arrangement can thus reduce cross talk more effectively than a conventional method for canceling optical cross talk with use of only a driving circuit in the liquid crystal panel. As such, it is possible to prevent a decrease in display quality which decrease is caused by optical cross talk. Further, the present invention can be worked with use of a circuit configuration simpler than in a conventional method for canceling optical cross talk.

In order to solve the above problems, a liquid crystal display device of the present invention includes: a liquid crystal panel including pixels arranged in a matrix; and a backlight that irradiates the liquid crystal panel with light, the pixels each including a plurality of picture elements that are different from one another in color, the picture elements each being provided with a color filter corresponding to a color of the picture element, the backlight including light sources having respective colors that correspond to picture elements having a plurality of colors, the liquid crystal display device further comprising: an aperture ratio converting section that, in order to reduce a gray scale difference between the picture elements in a pixel, converts aperture ratios, included in inputted image data, of said picture elements in the pixel and outputs data of the converted aperture ratios; and a backlight luminance control section that, in order to correct the gray scale difference between said picture elements in the pixel which gray scale difference has been reduced by the aperture ratio converting section, (i) increases, over a luminance of a light source having a color identical to a color of a picture element of which an aperture ratio is not changed by the aperture ratio converting section, a luminance of a light source having a color identical to a color of a picture element of which an aperture ratio is decreased by the aperture ratio converting section and (ii) decreases, against the luminance of the light source having the color identical to the color of the picture element of which the aperture ratio is not changed by the aperture ratio converting section, a luminance of a light source having a color identical to a color of a picture element of which an aperture ratio is increased by the aperture ratio converting section, the liquid crystal display device carrying out an intended gray scale display on a basis of (i) backlight luminances determined by the backlight luminance control section and (ii) aperture ratios of the respective picture elements in the liquid crystal panel, said aperture ratios having been obtained through an aperture ratio conversion process by the aperture ratio converting section.

The liquid crystal display device of the present invention includes: a liquid crystal panel including pixels arranged in a matrix; and a backlight that irradiates the liquid crystal panel with light. The pixels each include a plurality of picture elements that are different from each other in color. This means that one pixel is made up of picture elements having a plurality of colors. The picture elements, each serving as a part of a pixel, are called sub-pixels as well. Further, the backlight includes light sources having respective colors corresponding to the respective colors of the picture elements.

The liquid crystal display device of the present invention includes an aperture ratio converting section that, in order to reduce a gray scale difference between the picture elements in a pixel, converts aperture ratios of the picture elements in the pixel for inputted image data and outputs data of the converted aperture ratios. The aperture ratio converting section reduces an aperture ratio difference (that is, a gray scale difference caused by an aperture ratio difference) between adjacent picture elements for inputted image data, and outputs data of the aperture ratio difference reduced from its inputted state. This arrangement reduces the amount of electrical cross talk occurring due to a large gray scale difference between picture elements having the respective colors and constituting a pixel.

The liquid crystal display device of the present invention further includes a backlight luminance control section that serves to compensate for a change in a display gray scale of each picture element which change is caused by the above aperture ratio conversion process. The backlight luminance control section carries out a control to (i) increase, over a luminance of a light source having a color identical to a color of a picture element of which an aperture ratio is not changed by the aperture ratio converting section, a luminance of a light source having a color identical to a color of a picture element of which an aperture ratio has been decreased by the aperture ratio converting section and (ii) decreases, against the luminance of the light source having the color identical to the color of the picture element of which the aperture ratio is not changed by the aperture ratio converting section, a luminance of a light source having a color identical to a color of a picture element of which an aperture ratio is increased by the aperture ratio converting section. The liquid crystal display device thus carries out an intended gray scale display on the basis of (i) backlight luminances determined by the backlight luminance control section and (ii) aperture ratios of the respective picture elements in the liquid crystal panel, the aperture ratios having been obtained through an aperture ratio conversion process by the aperture ratio converting section.

In other words, the liquid crystal display device of the present invention causes the aperture ratio converting section to process image data, transmitted to the liquid crystal panel, so as to reduce the amount of electrical cross talk, and changes a backlight luminance to compensate for a shift from an intended gray scale in image data which shift occurs due to the above aperture ratio conversion process.

The above arrangement prevents the occurrence of or reduces the amount of electrical cross talk itself. The above arrangement can thus reduce cross talk more effectively than a conventional method for canceling electrical cross talk with use of only a driving circuit in the liquid crystal panel. As such, it is possible to prevent a decrease in display quality which decrease is caused by electrical cross talk. Further, the present invention can be worked with use of a circuit configuration simpler than in a conventional method for canceling electrical cross talk.

In order to solve the above problems, a method of the present invention for controlling display of a liquid crystal display device is a method for controlling display of a liquid crystal display device including: a liquid crystal panel including pixels arranged in a matrix; and a backlight that irradiates the liquid crystal panel with light, the pixels each including a plurality of picture elements that are different from one another in color, the picture elements each being provided with a color filter corresponding to a color of the picture element, the method comprising: an aperture ratio converting step for, in order to reduce light which has a wavelength of a color different from the color of the picture element and which is transmitted through the color filter with which the picture element is provided, decreasing an aperture ratio, included in inputted image data, of a picture element and outputting data of the decreased aperture ratio; and a backlight luminance control step for, in order to supplement the aperture ratio decreased in the aperture ratio converting step, increasing a backlight luminance as compared to a case in which the aperture ratio is not decreased, the liquid crystal display device carrying out an intended gray scale display on a basis of (i) backlight luminances determined in the backlight luminance control step and (ii) aperture ratios of the respective picture elements in the liquid crystal panel, said aperture ratios having been obtained through an aperture ratio conversion process in the aperture ratio converting step.

The above method, in order to correct optical cross talk, not only converts the aperture ratios of the respective picture elements for image data, but also utilizes a control of backlight luminances. In other words, the above method causes the liquid crystal display device to carry out an intended gray scale display by so utilizing the backlight luminances as to compensate for a shift of an image display from an intended gray scale which shift occurs due to an aperture ratio conversion carried out to reduce optical cross talk.

This arrangement reduces the amount of optical cross talk itself. It follows that it is possible to reduce optical cross talk occurring due to a factor beyond prediction, and consequently to improve display quality. Further, the present invention can be worked with use of a circuit configuration simpler than in a conventional method for canceling optical cross talk.

In order to solve the above problems, a method of the present invention for controlling display of a liquid crystal display device is a method for controlling display of a liquid crystal display device including: a liquid crystal panel including pixels arranged in a matrix; and a backlight that irradiates the liquid crystal panel with light, the pixels each including a plurality of picture elements that are different from one another in color, the picture elements each being provided with a color filter corresponding to a color of the picture element, the backlight including light sources having respective colors that correspond to picture elements having a plurality of colors, the method comprising: an aperture ratio converting step for, in order to reduce a gray scale difference between the picture elements in a pixel, converting aperture ratios of said picture elements in the pixel for inputted image data and outputting data of the converted aperture ratios; and a backlight luminance control step for, in order to correct the gray scale difference between said picture elements in the pixel which gray scale difference has been reduced in the aperture ratio converting step, (i) increasing, over a luminance of a light source having a color identical to a color of a picture element of which an aperture ratio is not changed in the aperture ratio converting step, a luminance of a light source having a color identical to a color of a picture element of which an aperture ratio is decreased in the aperture ratio converting step and (ii) decreasing, against the luminance of the light source having the color identical to the color of the picture element of which the aperture ratio is not changed in the aperture ratio converting step, a luminance of a light source having a color identical to a color of a picture element of which an aperture ratio is increased in the aperture ratio converting step, the method causing the liquid crystal display device to carry out an intended gray scale display on a basis of (i) backlight luminances determined in the backlight luminance control step and (ii) aperture ratios of the respective picture elements in the liquid crystal panel, said aperture ratios having been obtained through an aperture ratio conversion process in the aperture ratio converting step.

The above method, in order to correct electrical cross talk, not only converts the aperture ratios of the respective picture elements for image data, but also utilizes a control of backlight luminances. In other words, the above method causes the liquid crystal display device to carry out an intended gray scale display by so utilizing the backlight luminances as to compensate for a shift of an image display from an intended gray scale which shift occurs due to an aperture ratio conversion carried out to reduce electrical cross talk.

This arrangement reduces the amount of electrical cross talk itself. It follows that it is possible to reduce electrical cross talk occurring due to a factor beyond prediction, and consequently to improve display quality. Further, the present invention can be worked with use of a circuit configuration simpler than in a conventional method for canceling electrical cross talk.

### Advantageous Effects of Invention

The present invention prevents the occurrence of or reduces the amount of optical cross talk itself. The present invention can thus reduce cross talk more effectively than a conventional method for canceling optical cross talk with use of only a driving circuit in the liquid crystal panel. As such, it is possible to prevent a decrease in display quality which decrease is caused by optical cross talk.

The present invention prevents the occurrence of or reduces the amount of electrical cross talk itself. The present invention can thus reduce cross talk more effectively than a conventional method for canceling electrical cross talk with use of only a driving circuit in the liquid crystal panel. As such, it is possible to prevent a decrease in display quality which decrease is caused by electrical cross talk.

### BRIEF DESCRIPTION OF DRAWINGS

FIG. 1 is a block diagram illustrating an arrangement for controlling, in accordance with a first embodiment of the present invention, an operation of a liquid crystal display device illustrated in FIG. 2.

FIG. 2 is a cross-sectional view illustrating a configuration of liquid crystal display devices in accordance with the respective first, third, and fourth embodiments of the present invention.

FIG. 3 is a diagram schematically illustrating an example conversion of image data and backlight data which conversion is carried out in the liquid crystal display device illustrated in FIG. 1.

FIG. 4 (a) illustrates an expression color for the case in which expressing gray scale values for image data requires the luminances (R, G, B)=(100, 100, 30), (b) illustrates a reproduction color obtained in the case in which a cross talk correction illustrated in FIG. 3 has been carried out with respect to the image data indicative of the expression color of (a), and (c) illustrates a reproduction color obtained in the case in which no correction of optical cross talk has been carried out with respect to the image data indicative of the expression color of (a).

FIG. 5 is a diagram schematically illustrating a configuration of a liquid crystal display device including an area active drive backlight.

FIG. 6 is a cross-sectional view illustrating a configuration of a liquid crystal display device in accordance with a second embodiment of the present invention.

FIG. 7 is a block diagram illustrating an arrangement for controlling an operation of the liquid crystal display device illustrated in FIG. 6.

FIG. 8 is a diagram schematically illustrating an example conversion of image data and backlight data which conversion is carried out in the liquid crystal display device illustrated in FIG. 7.

FIG. 9 (a) illustrates an expression color for the case in which expressing gray scale values for image data requires the luminances (R, G, B)=(100, 100, 30), (b) illustrates a reproduction color obtained in the case in which a cross talk correction illustrated in FIG. 7 has been carried out with respect to the image data indicative of the expression color of (a), and (c) illustrates a reproduction color obtained in the case in which no correction of optical cross talk has been carried out with respect to the image data indicative of the expression color of (a).

FIG. 10 is a block diagram illustrating an arrangement for controlling, in accordance with the third embodiment of the present invention, an operation of a liquid crystal display device illustrated in FIG. 2.

FIG. 11 is a diagram schematically illustrating an example conversion of image data and backlight data which conversion is carried out in the liquid crystal display device illustrated in FIG. 10.

FIG. 12 (a) illustrates an expression color for the case in which expressing gray scale values for image data requires the luminances (R, G, B)=(100, 100, 30), (b) illustrates a reproduction color obtained in the case in which a cross talk correction illustrated in FIG. 11 has been carried out with respect to the image data indicative of the expression color of (a), and (c) illustrates a reproduction color obtained in the case in which no correction of electrical cross talk has been carried out with respect to the image data indicative of the expression color of (a).

FIG. 13 is a block diagram illustrating an arrangement for controlling, in accordance with the fourth embodiment of the present invention, an operation of a liquid crystal display device illustrated in FIG. 2.

FIG. 14 is a graph illustrating respective transmittance properties of color filters having the respective colors of R, G, and B.

FIG. 15 is a diagram schematically illustrating an example of optical cross talk.

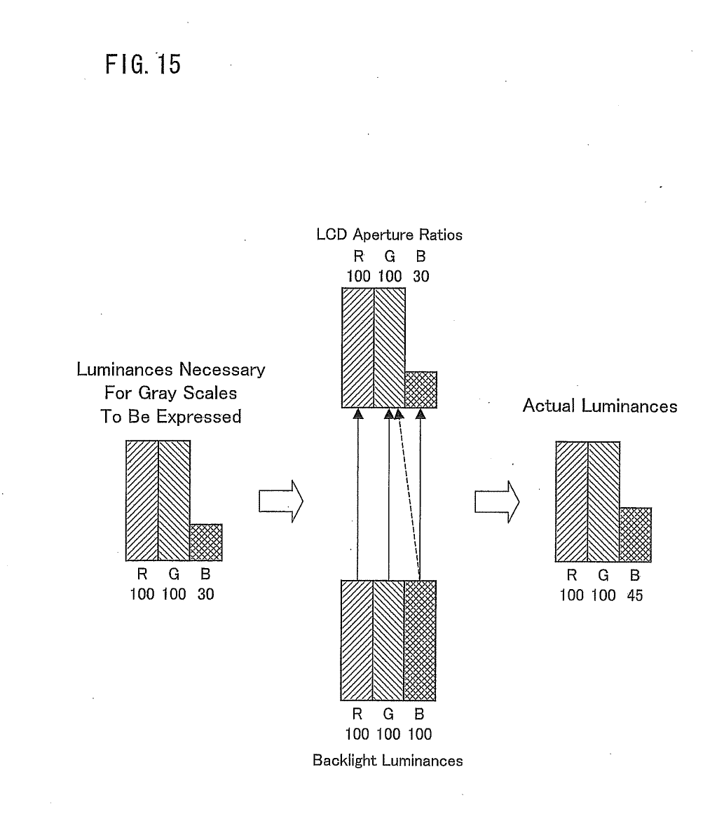

FIG. 16 is a diagram schematically illustrating an example of electrical cross talk.

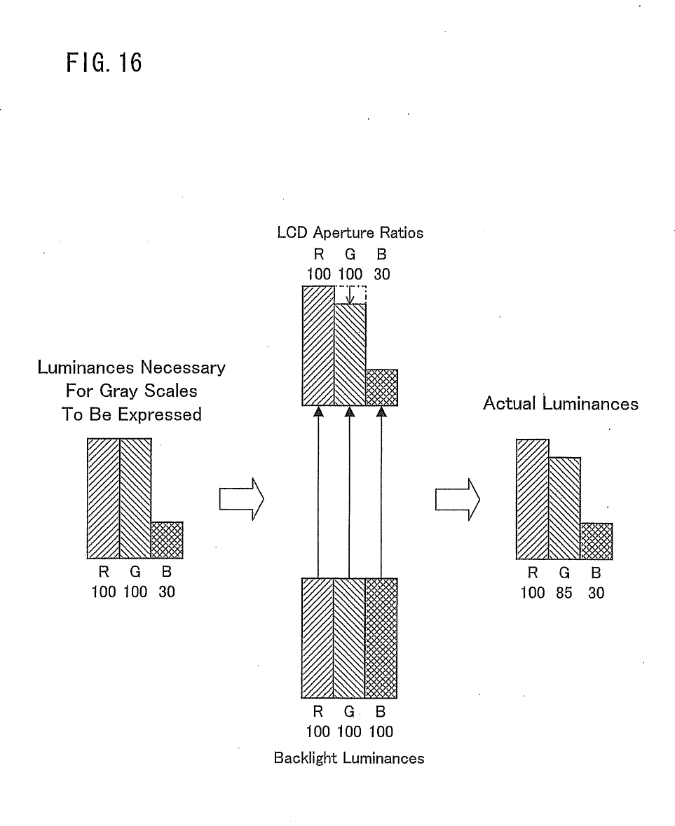

FIG. 17 is a diagram schematically illustrating an example conventional method for canceling optical cross talk.

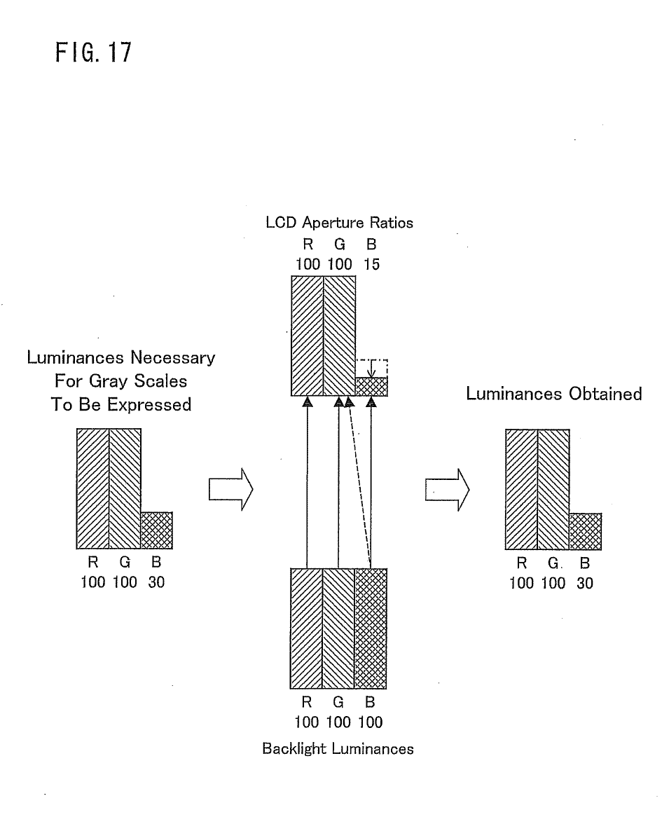

FIG. 18 is a diagram schematically illustrating an example conventional method for canceling electrical cross talk.

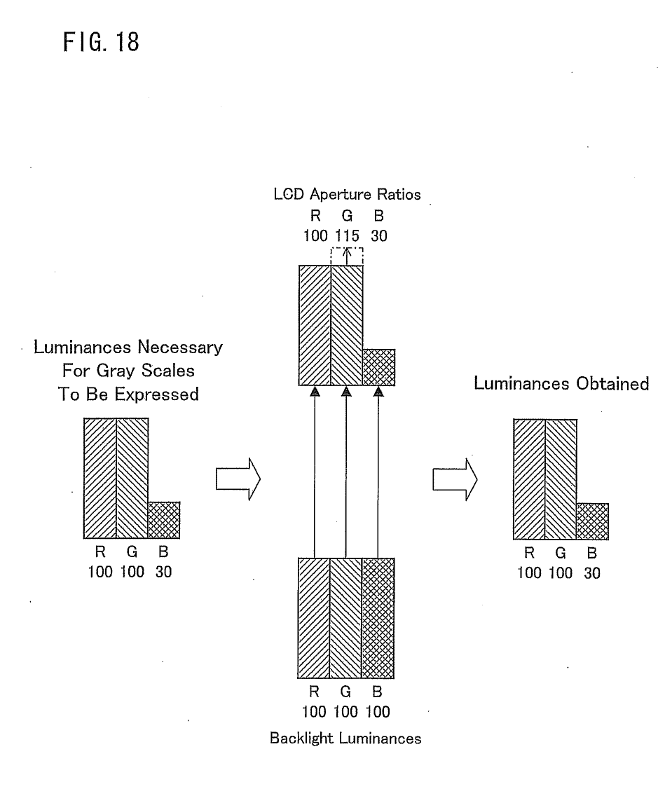

### DESCRIPTION OF EMBODIMENTS

### Embodiment 1

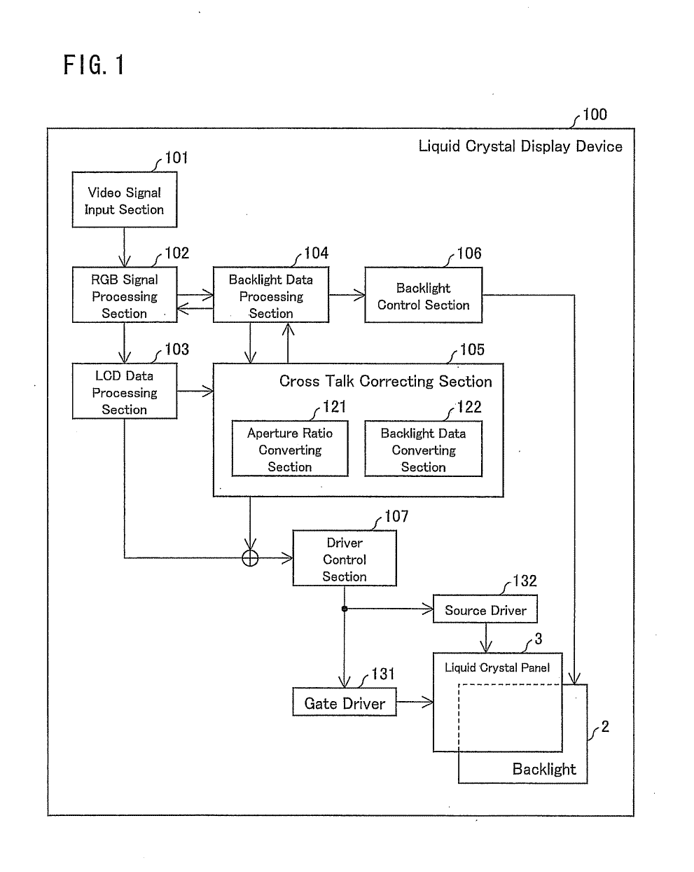

An embodiment of the present invention is described below with reference to FIGS. 1 through 5. The present invention is not limited to the embodiment below.

The present embodiment described below is a liquid crystal display device that (i) includes: a liquid crystal panel; and a backlight for emitting light onto the liquid crystal panel and that (ii) determines backlight luminances and aperture ratios of respective picture elements on the basis of gray scale values of inputted video signals (image data) to carry out an intended gray scale display.

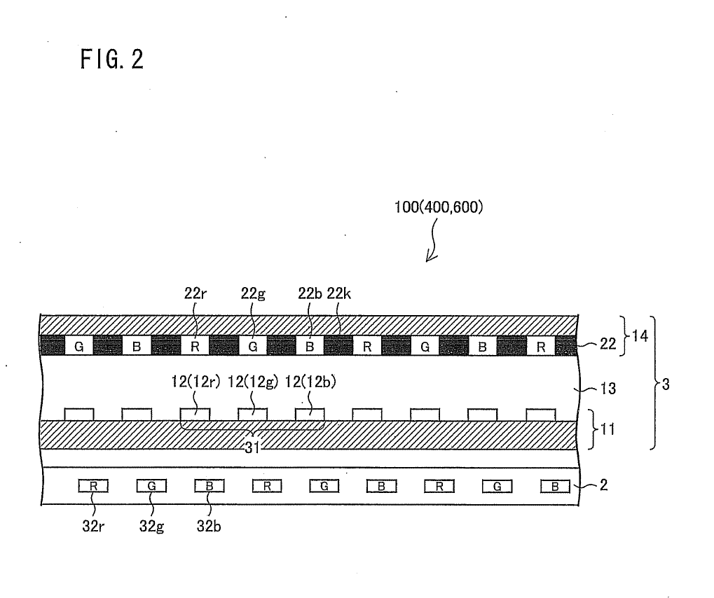

FIG. 2 illustrates a cross-sectional configuration of the liquid crystal display device of the present embodiment. As illustrated in FIG. 2, the liquid crystal display device 100 of the present embodiment includes: a liquid crystal panel 3; and a backlight 2 provided behind the liquid crystal panel 3.

The backlight 2 is adapted to emit light toward the liquid crystal panel 3. The backlight 2 of the present embodiment includes a plurality of red LEDs 32r each serving as a red (R) light source, a plurality of green LEDs 32g each serving as a green (G) light source, and a plurality of blue LEDs 32b each serving as a blue (B) light source.

The liquid crystal panel 3 includes: an active matrix substrate 11; a counter substrate 14; and a liquid crystal layer 13 provided between the active matrix substrate 11 and the counter substrate 14.

The active matrix substrate 11 includes in a surface thereof: a plurality of scanning signal lines (not shown); and a plurality of data signal lines (not shown) crossing the scanning signal lines. The active matrix substrate 11 further includes TFTs that (i) are provided in the vicinity of intersections of the scanning signal lines with the data signal lines and that (ii) each serve as a switching element. The active matrix substrate 11 includes picture element electrodes 12 provided in respective squares in a grid formed by the scanning signal lines and the data signal lines crossing the scanning signal lines. Each picture element electrode 12 corresponds to a single picture element.

The counter substrate 14 includes a color filter layer 22 in addition to members such as a counter electrode and an alignment film (not shown). The color filter layer 22 includes: color filter sections 22r, 22g, and 22b having the respective colors of red (R), green (G), and blue (B); and (ii) a black matrix 22k.

The liquid crystal panel 3 of the present embodiment, which includes the above color filter sections having the respective colors of red (R), green (G), and blue (B), can carry out a color image display on the basis of image data for the above three colors. Specifically, each picture element electrode 12 corresponding to a red color filter section 22r serves as a red picture element 12r, each picture element electrode 12 corresponding to a green color filter section 22g serves as a green picture element 12g, and each picture element electrode 12 corresponding to a blue color filter section 22b serves as a blue picture element 12b.

Such three picture elements, namely a red picture element 12r, a green picture element 12g, and a blue picture element 12b, constitute a single pixel 31. The picture elements 12 (12r, 12g, and 12b) are thus each referred to also as a sub-pixel.

The following describes, with reference to FIG. 1, an arrangement for controlling respective operations of the liquid crystal panel 3 and the backlight 2.

As illustrated in FIG. 1, the liquid crystal display device 100 includes, for example: a video signal input section 101; an RGB signal processing section 102; an LCD data processing section 103; a backlight data processing section 104; a cross talk correcting section 105; a backlight control section 106 (backlight luminance control section); a driver control section 107; a gate driver 131; and a source driver 132. These sections and drivers are each formed by a circuit.

The video signal input section 101 receives video signals transmitted from, for example, a TV receiver, a VTR, or a DVD, and transmits those video signals to the RGB signal processing section 102.

The RGB signal processing section 102 generates, on the basis of the video signals transmitted thereto, image data to be transmitted to the picture elements. In the present embodiment, the RGB signal processing section 102 generates R image data, G image data, and B image data as image data to be transmitted to the picture elements having the respective colors of R, G, and B. The RGB signal processing section 102 transmits the image data thus generated to the LCD data processing section 103 and the backlight data processing section 104.

The LCD data processing section 103 carries out, on the basis of the image data transmitted thereto, a data processing so that the liquid crystal panel will display a target image.

The backlight data processing section 104 determines backlight output values on the basis of the image data transmitted from the RGB signal processing section 102. The backlight output values can be determined by, for example, a method in which are calculated (i) a maximum gray scale value (in the case where backlight luminance is controlled for individual regions, a maximum gray scale value for each region) of the inputted image data and (ii) an average gray scale value of the inputted image data, so that backlight output values are determined on the basis of the maximum gray scale value and the average gray scale value thus calculated.

The cross talk correcting section 105 serves to reduce optical cross talk occurring due to a relation between (i) respective properties of color filters provided in the liquid crystal panel 3 and (ii) respective aperture ratios (transmittances) of the picture elements. The cross talk correcting section 105 thus includes: an aperture ratio converting section 121 for converting data of the aperture ratios of the respective picture elements, the data being transmitted to the liquid crystal panel 3; and a backlight data converting section 122 (backlight luminance control section) for converting backlight data.

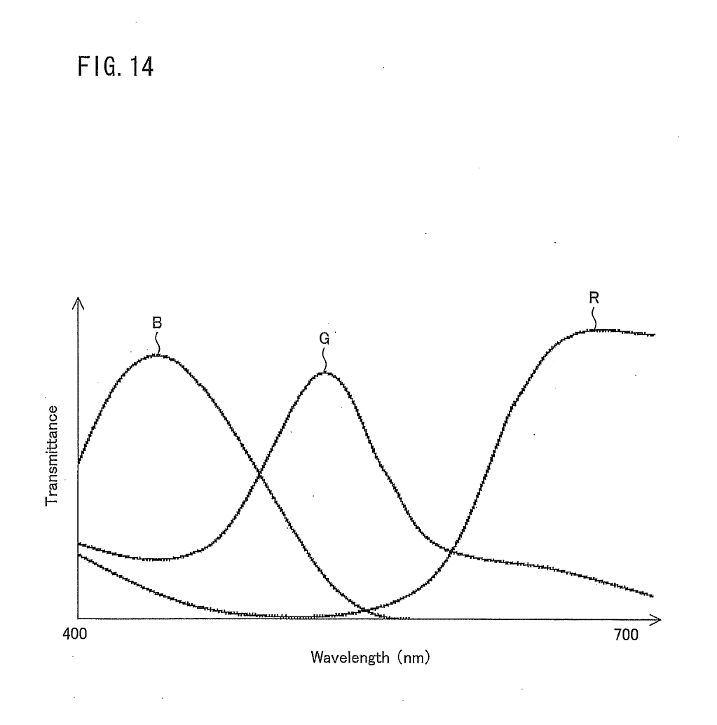

The aperture ratio converting section 121 decreases the aperture ratio for image data for the green picture element among the image data that corresponds to the respective colors of R, G, and B and that has been transmitted from the LCD data processing section 103. The aperture ratio converting section 121 does not convert the aperture ratio for image data for picture elements of any other color. This is because the pixel 31 of the liquid crystal panel 3 of the present embodiment is constituted by picture elements 12 provided with respective color filters that have their respective colors and color filter properties illustrated in FIG. 14.

The conversion process carried out by the aperture ratio converting section of the present invention is not limited to a process such as the above. The aperture ratio converting section is simply required to decrease an aperture ratio in accordance with the respective properties of color filters provided for the individual picture elements, that is, to decrease the aperture ratio for image data for a picture element provided with a color filter that transmits an amount of light having a color other than the color of the picture element, the amount being greater than in the other color filters.

The backlight data converting section 122, since the aperture ratio converting section 121 decreases the aperture ratio for image data for green, carries out a conversion process with respect to backlight data to increase the luminance of the green LED 32g over the light sources for the other colors in order to supplement the luminance of a green image.

The luminance conversion process carried out by the backlight data converting section (backlight luminance control section) of the present invention is not limited to a process such as the above. The backlight luminance control section is simply required to increase, over the luminance of the light source of any other color, the luminance of the light source having a color identical to the color of a picture element for which the aperture ratio converting section decreases an aperture ratio.

The backlight control section 106 controls, on the basis of the backlight data transmitted from the backlight data processing section 104, respective luminances of the light sources having the respective colors of R, G, and B. The backlight control section 106 receives backlight data including data obtained through the conversion carried out by the backlight data converting section 122 included in the cross talk correcting section.

The driver control section 107 controls the gate driver 131 and the source driver 132 on the basis of (i) data transmitted from the LCD data processing section 103 and (ii) data transmitted from the aperture ratio converting section 121 included in the cross talk correcting section 105.

The gate driver 131 is connected to scanning signal lines included in the liquid crystal panel 3, and supplies scanning signals to the scanning signal lines.

The source driver 132 is connected to data signal lines included in the liquid crystal panel 3, and supplies data signals to the data signal lines. The aperture ratio data as converted by the aperture ratio converting section 121 is transmitted to the individual picture elements 12 via the source driver 132 and the data signal lines. The picture elements 12 carry out a display on the basis of the aperture ratio data thus transmitted.

The following describes an example of a method for controlling image display carried out by the liquid crystal display device 100 of the present embodiment.

The description below uses the expression (R, G, B)=(100, 100, 30) to collectively refer to any case where luminances of, for example, 100, 100, and 30 are necessary to express image data having gray scale values corresponding to picture elements 12r, 12g, and 12b constituting a pixel 31 in the liquid crystal panel 3. Further, the description below uses the expression (R, G, B)=(100, 100, 30) to collectively refer to any case where luminances of backlight data which luminances correspond to light sources having the respective colors of R, G, and B are, for example, 100, 100, and 30. As described above, the brightness (luminance) of a picture element can be expressed in the form of the aperture ratio of the picture element, and is expressed as a number within the range from 0 to 100 in the present embodiment.

In other words, the present specification numerically presents, as an aperture ratio, a luminance for expressing a target gray scale in a picture element of the LCD. The present specification further numerically presents luminances of the respective backlight colors. The description below in the present specification numerically presents an expression color to refer to a luminance necessary to express a target gray scale value. This means that (i) the numerically presented expression color and the aperture ratio of a picture element are each a value directly proportional to a corresponding luminance and that (ii) a numerically presented backlight luminance is equal to the value of a corresponding luminance itself. Further, the numerically presented expression color is directly proportional to the multiple of the aperture ratio of the picture element and the backlight luminance. In the case where, for example, the expression color is 100, the backlight luminance is 100 if the aperture ratio of the picture element is 100, and the backlight luminance is 200 if the aperture ratio of the picture element is 50.

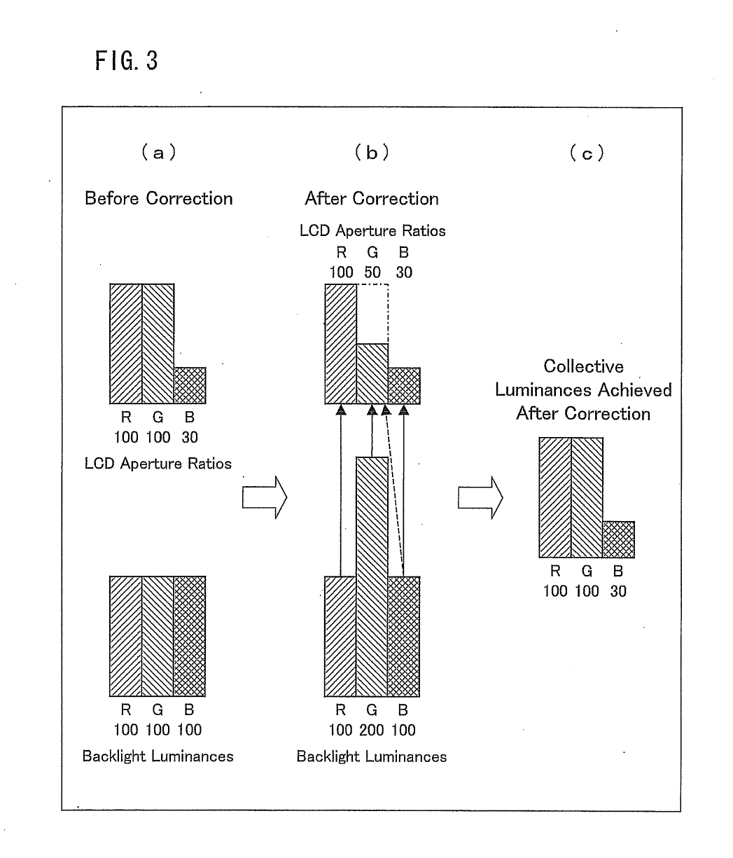

FIG. 3 illustrates an example of how conversion is carried out with respect to image data and backlight data for the picture elements 12r, 12g, and 12b constituting a pixel 31 in the liquid crystal panel 3. The example of FIG. 3 is of the case in which the luminance of the green LED 32g for the backlight is doubled, and the aperture ratio of the G picture element 12g in the liquid crystal panel (LCD) is halved. These correction amounts are, however, merely an example. The present invention is not limited by such correction amounts. It is simply necessary that in the case where, for example, the luminance of a light source of the backlight is multiplied by n, the aperture ratio of a picture element having a color identical to the color of the light source be 1/n, where n is a value greater than 1.

(a) of FIG. 3 illustrates example aperture ratios of the respective picture elements 12r, 12g, and 12b constituting a pixel 31 in the liquid crystal panel (LCD) 3, the aperture ratios being observed before cross talk correction. These pieces of image data have been generated by the LCD data processing section 103 on the basis of data transmitted from the RGB signal processing section 102. (a) of FIG. 3 further illustrates luminance data for the respective light sources for R, G, and B in the backlight. This luminance data has been generated by the backlight data processing section 104 on the basis of data transmitted from the RGB signal processing section 102. The description herein uses the term “expression color” to refer to a pixel color expressed by combining (i) the aperture ratios of the respective picture elements for image data in (a) of FIG. 3 with (ii) the backlight luminances.

(b) of FIG. 3 illustrates (i) image data obtained through conversion, by the aperture ratio converting section 121 and the backlight data converting section 122 both included in the cross talk correcting section 105, of image data corresponding to the image data of (a), and (ii) backlight data.

As illustrated in (b) of FIG. 3, the aperture ratios of the LCD are converted from (100, 100, 30) to (100, 50, 30) through a process by the aperture ratio converting section 121. The backlight luminances are, on the other hand, converted from (100, 100, 100) to (100, 200, 100) through a process by the backlight data converting section 122.

The data of the aperture ratios of the LCD, the data having been obtained through the conversion by the aperture ratio converting section 121, is then transmitted to the driver control section 107 along with image data generated by the LCD data processing section 103. The driver control section 107 generates, on the basis of the image data thus transmitted thereto, various signals to be transmitted to the gate driver 131 and the source driver 132.

The luminance data obtained through the conversion by the backlight data converting section 122 is transmitted back to the backlight data processing section 104. The backlight data processing section 104 carries out a data processing on the basis of the luminance data transmitted thereto, and transmits the processed luminance data to the backlight control section 106 for driving the backlight 2.

(c) of FIG. 3 illustrates collective luminances obtained by combining image data for the picture elements with backlight luminances, the image data and the backlight luminances both having been obtained through cross talk correction by the cross talk correcting section 105. The description herein uses the term “reproduction color” to refer to a pixel color expressed by combining (i) aperture ratios of the respective picture elements with (ii) backlight luminances, the aperture ratios and the backlight luminances having been obtained through cross talk correction. An ideal data conversion process will result in a reproduction color being identical to its corresponding expression color.

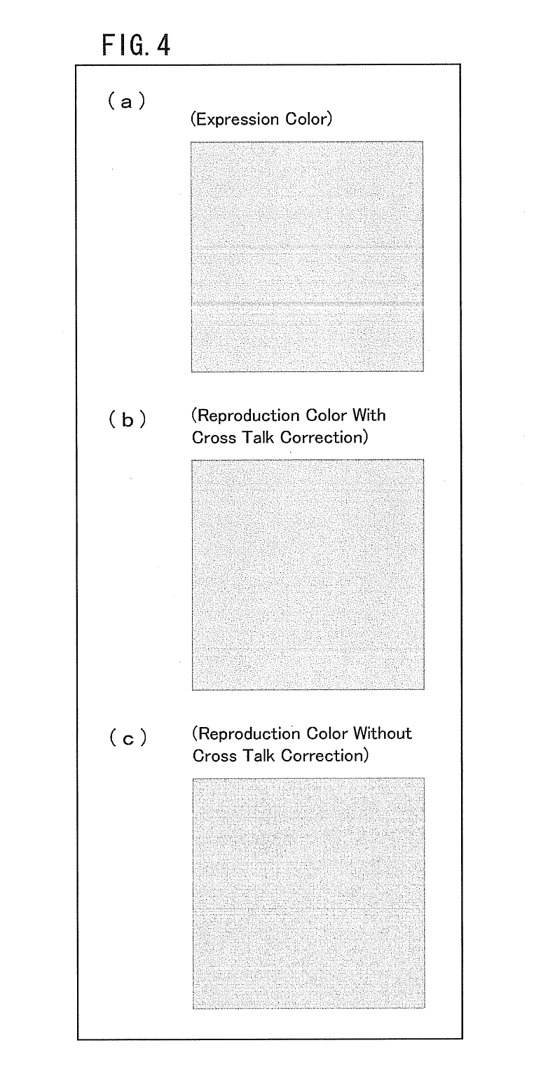

FIG. 4 illustrates an example of an expression color and a reproduction color both obtained in the case where the data conversion process illustrated in FIG. 3 has been carried out. (a) of FIG. 4 illustrates an expression color with (R, G, B)=(100, 100, 30). (b) of FIG. 4 illustrates a reproduction color obtained in the case where the data conversion process illustrated in FIG. 3 has been carried out. (c) of FIG. 4 illustrates for comparison a reproduction color obtained in the case where no data conversion process has been carried out, so that optical cross talk has occurred.

As illustrated in (c) of FIG. 4, carrying out no data conversion process results in occurrence of optical cross talk and thus in generation of a color different from the expression color (that is, occurrence of a color shift). In contrast, carrying out the data conversion process of the present embodiment enables generation of a reproduction color substantially identical to the expression color (see (b) of FIG. 4).

Although it is difficult to recognize a chromaticity difference between the monochrome images of FIG. 4, the reproduction color of (c) of FIG. 4, obtained with no data conversion process carried out, is greater in blueness and more grayish overall than the expression color of (a) of FIG. 4, and looks, to the naked eye, clearly different from (a) of FIG. 4. On the other hand, the reproduction color of (b) of FIG. 4, obtained with a data conversion process carried out, does not have as large an increase in blueness as above, and has a hue that looks, to the naked eye, substantially identical to the hue of the expression color of (a) of FIG. 4.

The respective colors of (a) through (c) of FIG. 4 are numerically expressed in gray scale values for R, G, and B as: (R, G, B)=(100, 100, 30); (R, G, B)=(100, 100, 30); and (R, G, B)=(100, 100, 45).

The liquid crystal display device 100 of the present embodiment, which carries out the above display control, carries out an aperture ratio conversion process for collectively decreasing the aperture ratio of the green picture element 12g, and consequently reduces light that has the wavelength for blue and that is transmitted by the green color filter section 22g. Further, the liquid crystal display device 100, in order to supplement green light having a transmittance decreased by the above aperture ratio conversion process, increases the luminance of the green LED 32g on the basis of backlight data as converted by the backlight data converting section 122. This arrangement makes it possible to, for example, prevent or reduce optical cross talk itself.

### Variation of Embodiment 1

The backlight 2 of the above liquid crystal display device 100 is capable of individually controlling the respective luminances of light sources of the respective colors of R, G, and B, and emits light having a luminance that is uniform over the entire light-emitting surface of the backlight 2. The present invention is also applicable to a liquid crystal display device including an area active drive backlight, the liquid crystal display device being capable of individually controlling respective luminances of a plurality of divisional light-emitting regions, into which the light-emitting surface of the backlight is divided.

The following describes (i) a configuration of a liquid crystal display device including such an area active drive backlight and (ii) a method for controlling display of that liquid crystal display device. No description is provided here of (i) members of the liquid crystal display device of the present variation which members are identical to their respective corresponding members of the liquid crystal display device 100 and (ii) portions of the method of the present variation which portions are identical to their respective corresponding portions of the method for controlling display of the liquid crystal display device 100.

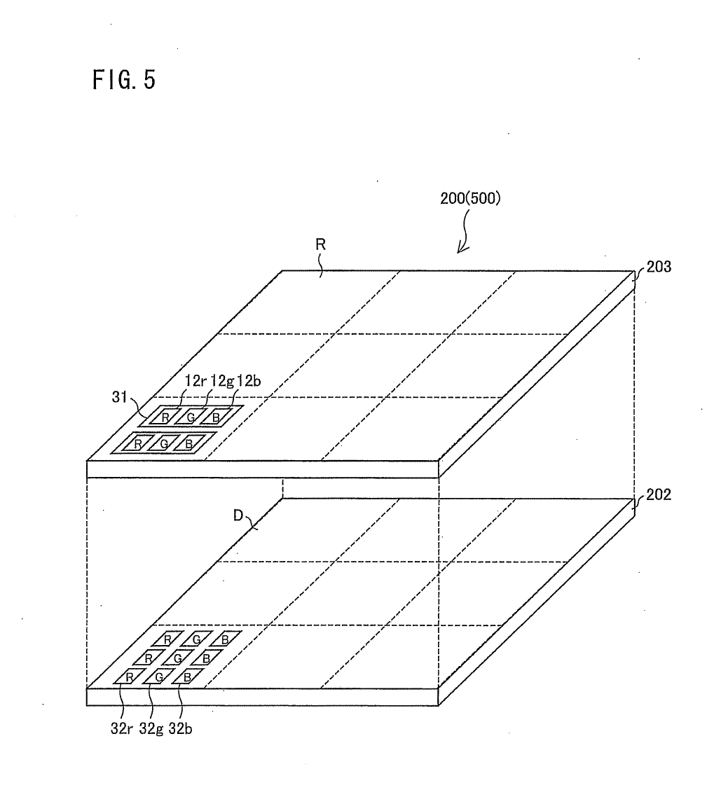

FIG. 5 illustrates a liquid crystal display device 200 including an area active drive backlight 202. As illustrated in FIG. 5, the backlight 202 has a light-emitting surface that is divided into regions D arranged in three rows and three columns. The liquid crystal display device 200 includes a liquid crystal panel 203, which can be virtually divided into divisional display regions R that are arranged in a matrix of three rows and three columns and that correspond to the divisional light-emitting regions D of the backlight 202. The backlight 202 includes, in each of the divisional light-emitting regions D, a plurality of red LEDs 32r, a plurality of green LEDs 32g, and a plurality of blue LEDs 32b each serving as a light source. The liquid crystal panel 203 includes, in each of the divisional display regions R, a plurality of pixels 31, 31, . . . .

The following describes a method for carrying out an area active drive in the liquid crystal display device 200. How the liquid crystal display device 200 is operated can be controlled with use of a configuration similar to that illustrated in FIG. 1. The description below thus refers to FIG. 1.

First, as in Embodiment 1, the RGB signal processing section 102 generates image data for the individual picture elements on the basis of video signals transmitted thereto, and transmits the image data to the backlight data processing section 104. The backlight data processing section 104 detects from the image data transmitted thereto a maximum gray scale in all picture elements of R, G, and B for each divisional display region R of the liquid crystal panel 203 (regardless of the color). The backlight data processing section 104 then determines, on the basis of the maximum gray scale thus detected, backlight data for the divisional light-emitting region D corresponding to the divisional display region R.

The above-determined backlight data for each region D is transmitted to the LCD data processing section 103 via the RGB signal processing section 102. The LCD data processing section 103 converts data for the individual picture elements on the basis of image data for the picture elements and the backlight data both transmitted to the LCD data processing section 103.

The following describes a specific example of the case in which an image display surface is divided into two divisional light-emitting regions D1 and D2 and into two divisional display regions R1 and R2 corresponding to the divisional light-emitting regions D1 and D2.

In the case where, for example, (i) picture elements of R, G, and B in R1 have a maximum gray scale of 100 and (ii) picture elements of R, G, and B in R2 have a maximum gray scale of 200, the backlight data processing section 104 sets (i) luminance data for light sources of the respective colors of R, G, and B in the region D1 to (R, G, B)=(100, 100, 100) and luminance data for light sources of the respective colors of R, G, and B in the region D2 to (R, G, B)=(200, 200, 200).

The LCD data processing section 103, in the case where input image data for a pixel in the region R1 which corresponds to the region D1 indicates (R, G, B)=(100, 100, 30), sets output image data to (R, G, B)=(100, 100, 30) by reflecting the above backlight data processing. The LCD data processing section 103, in the case where input image data for a pixel in the region R2 corresponding to the region D2 indicates (R, G, B)=(100, 100, 50), sets output image data to (R, G, B)=(50, 50, 25) by reflecting the above backlight data processing.

The LCD data processing section 103 can carry out the above data conversion process in accordance with, for example, (Formula 1) below for each of the colors R, G, and B:

Luminance (aperture ratio) necessary to express a gray scale value in output image data=[Luminance (aperture ratio) necessary to express a gray scale value in input image data]/(Luminance data)×100 (Formula 1)

The above method enables an area active drive of controlling backlight luminances and image data for the liquid crystal panel for each individual one of a plurality of regions into which an image display surface is divided.

The method of the present invention for an area active drive is not limited to the method described above, and can be a publicly known method such as a method disclosed in Patent Literature 3.

The image data and luminance data, which have been subjected to the above conversion process for each divisional region, are transmitted to the cross talk correcting section 105. The cross talk correcting section 105 can convert aperture ratios and luminance data as described for the above data conversion process of the liquid crystal display device 100. The conversion by the cross talk correcting section 105 is thus not described here.

Another possible method for the data conversion process is a method in which the rate of conversion of aperture ratios is varied for each region with use of, for example, a maximum gray scale value, a maximum aperture ratio, an average gray scale value, and an average aperture ratio for each region. An example of such control is as follows: For example, a maximum aperture ratio of G picture elements is calculated for each region. In the case where the calculated maximum aperture ratio for G is 80 or greater, the luminance of G LEDs is doubled, and the aperture ratio of the G picture elements is halved. In the case where the calculated maximum aperture ratio for G is smaller than 80, neither the luminance of the G LEDs nor the aperture ratio of the G picture elements is changed.

### Embodiment 2

Embodiment 1 above describes an example of a liquid crystal display device including a backlight that includes light sources of the respective colors of R, G, and B. The present invention is, however, not necessarily limited to such a configuration. Embodiment 2 below describes a method for reducing optical cross talk in a liquid crystal display device including a backlight that includes only white LEDs.

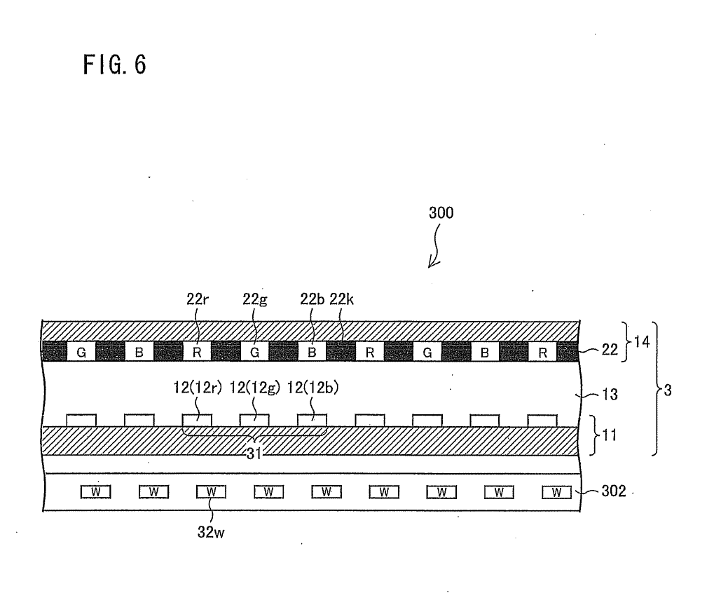

FIG. 6 illustrates a cross-sectional configuration of a liquid crystal display device 300 of the present embodiment. As illustrated in FIG. 6, the liquid crystal display device 300 includes: a liquid crystal panel 3; and a backlight 302. The liquid crystal panel 3 of the present embodiment is identical in configuration to the liquid crystal panel 3 of Embodiment 1, and is thus not described here.

The backlight 302 includes a plurality of white LEDs 32w each serving as a light source. The liquid crystal display device 300 differs in that point from the liquid crystal display device 100 of Embodiment 1. The white LEDs 32w emit light that includes all light beams having the wavelengths corresponding to the respective colors of R, G, and B. As described below, the light emitted by the white LEDs 32w has a luminance that can be adjusted by, for example, a backlight control section.

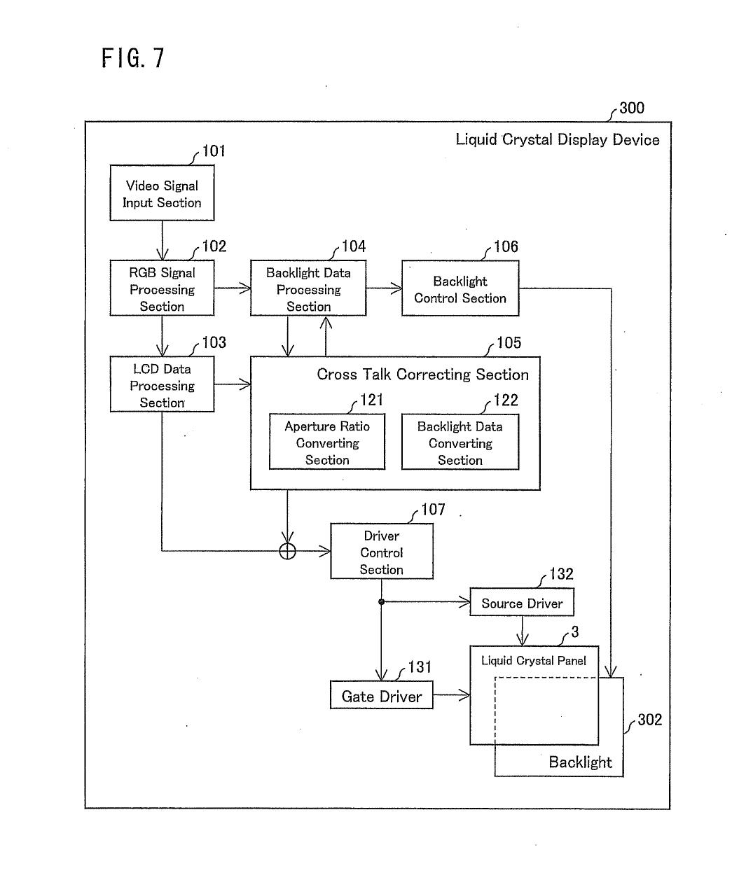

The following describes, with reference to FIG. 7, an arrangement for controlling respective operations of the liquid crystal panel 3 and the backlight 302. Members of the present embodiment that are functionally identical to their respective corresponding members of the above-described liquid crystal display device 100 are each assigned the same reference numeral, and not described here in detail.

As illustrated in FIG. 7, the liquid crystal display device 300 includes, for example: a video signal input section 101; an RGB signal processing section 102; an LCD data processing section 103; a backlight data processing section 104; a cross talk correcting section 105; a backlight control section 106 (backlight luminance control section); a driver control section 107; a gate driver 131; and a source driver 132. These sections and drivers are each formed by a circuit.

The liquid crystal display device 300 differs from the liquid crystal display device 100 in, among the members illustrated in FIG. 7, (i) a correction method carried out by the cross talk correcting section 105 and (ii) a luminance control method carried out by the backlight 302. The description below thus deals with such a difference.

The cross talk correcting section 105 serves to reduce optical cross talk occurring due to a relation between (i) respective properties of color filters provided in the liquid crystal panel 3 and (ii) respective aperture ratios (transmittances) of the picture elements. The cross talk correcting section 105 thus includes: an aperture ratio converting section 121 for converting data of the aperture ratios of the respective picture elements, the data being transmitted to the liquid crystal panel 3; and a backlight data converting section 122 (backlight luminance control section) for converting backlight data.

The aperture ratio converting section 121 carries out, with respect to image data that corresponds to the respective colors of R, G, and B and that has been transmitted from the LCD data processing section 103, an aperture ratio conversion process for decreasing the aperture ratios of all pixels over a single image display surface at an identical rate for the image data. The rate of the decrease in the aperture ratios is not particularly limited. The aperture ratios are decreased by half, for example. In this case, if a luminance (aperture ratio) necessary to express a gray scale value for input image data is 100, a luminance (aperture ratio) necessary to express a gray scale value for output image data is 50. This arrangement makes it possible to, for example, reduce the amount of blue light transmitted through the G picture element 12g among the picture elements provided with color filters of the respective colors having the color filter properties illustrated in FIG. 14.

The backlight data converting section 122, since the aperture ratio converting section 121 decreases the aperture ratios of the picture elements, carries out a conversion process with respect to backlight data to increase the luminance of the white LEDs 32w in order to compensate for a luminance decrease caused in a display image by the above decrease in the aperture ratios. The backlight data converting section 122 carries out the above data conversion process to offset the amount of the decrease in the aperture ratios which decrease has been caused by the aperture ratio converting section 121. In the case where, for example, the aperture ratio converting section 121 carries out a conversion to halve the aperture ratios, the backlight data converting section 122 carries out a data conversion to double the luminances of the white LEDs 32w.

The backlight control section 106 controls, on the basis of the backlight data transmitted from the backlight data processing section 104, the luminances of the white LEDs 32w. The backlight control section 106 receives backlight data including data obtained through the conversion carried out by the backlight data converting section 122 included in the cross talk correcting section.

The above arrangement makes it possible to carry out a target gray scale display with use of (i) backlight luminances determined by the backlight luminance control section and (ii) aperture ratios of the individual picture elements in the liquid crystal panel, the aperture ratios having been obtained through an aperture ratio conversion process carried out by the aperture ratio converting section.

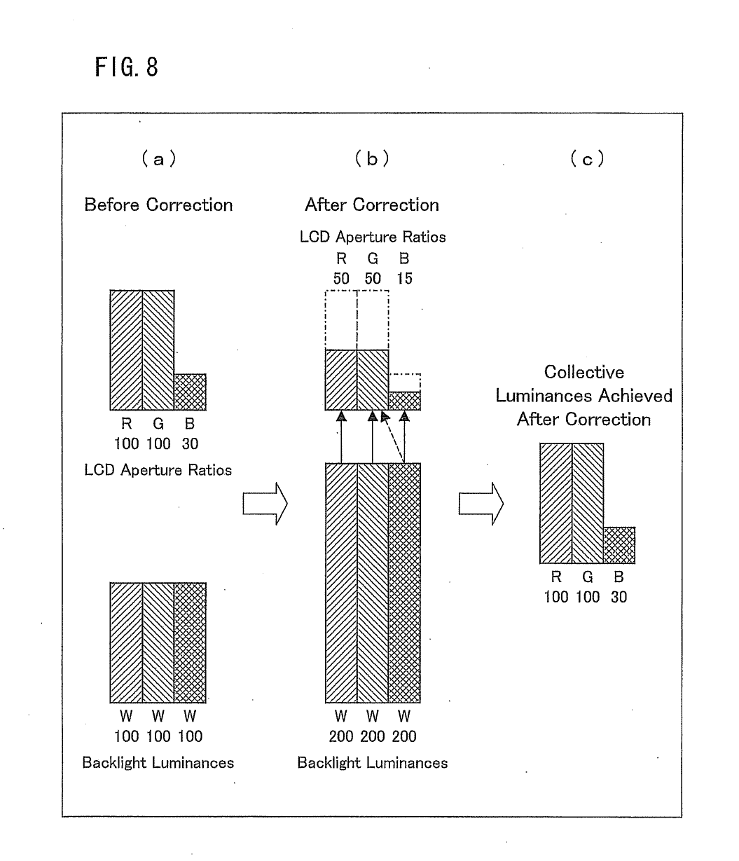

FIG. 8 illustrates an example of how conversion is carried out with respect to image data and backlight data for the picture elements 12r, 12g, and 12b constituting a pixel 31 in the liquid crystal panel 3. The example of FIG. 8 is of the case in which the luminance of the white LEDs 32w for the backlight is doubled, and the aperture ratios of the respective picture elements 12 (12r, 12g, and 12b) in the liquid crystal panel (LCD) are each halved. These correction amounts are, however, merely an example. The present invention is not limited by such correction amounts. It is simply necessary that in the case where, for example, the luminance of a light source of the backlight is multiplied by n, the aperture ratio of a picture element having a color identical to the color of the light source be 1/n, where n is a value greater than 1.

(a) of FIG. 8 illustrates example aperture ratios of the respective picture elements 12r, 12g, and 12b constituting a pixel 31 in the liquid crystal panel (LCD) 3, the aperture ratios being observed before cross talk correction. These pieces of image data have been generated by the LCD data processing section 103 on the basis of data transmitted from the RGB signal processing section 102. (a) of FIG. 8 further illustrates luminance data for white-light sources (w) of the backlight. This luminance data has been generated by the backlight data processing section 104 on the basis of data transmitted from the RGB signal processing section 102. The description herein uses the term “expression color” to refer to a pixel color expressed by combining (i) the aperture ratios of the respective picture elements for image data in (a) of FIG. 8 with (ii) the backlight luminances.

(b) of FIG. 8 illustrates (i) image data obtained through conversion, by the aperture ratio converting section 121 and the backlight data converting section 122 both included in the cross talk correcting section 105, of image data corresponding to the image data of (a), and (ii) backlight data.

As illustrated in (b) of FIG. 8, the aperture ratios of the LCD are converted from (100, 100, 30) to (50, 50, 15) through a process by the aperture ratio converting section 121. The backlight luminances are, on the other hand, converted from (100, 100, 100) to (200, 200, 200) through a process by the backlight data converting section 122.

The data of the aperture ratios of the LCD, the data having been obtained through the conversion by the aperture ratio converting section 121, is then transmitted to the driver control section 107 along with image data generated by the LCD data processing section 103. The driver control section 107 generates, on the basis of the image data thus transmitted thereto, various signals to be transmitted to the gate driver 131 and the source driver 132.

The luminance data obtained through the conversion by the backlight data converting section 122 is transmitted back to the backlight data processing section 104. The backlight data processing section 104 carries out a data processing on the basis of the luminance data transmitted thereto, and transmits the processed luminance data to the backlight control section 106 for driving the backlight 302.

(c) of FIG. 8 illustrates collective luminances obtained by combining image data for the picture elements with backlight luminances, the image data and the backlight luminances both having been obtained through cross talk correction by the cross talk correcting section 105. The description herein uses the term “reproduction color” to refer to a pixel color expressed by (i) image data for picture elements with (ii) backlight, the aperture ratios and the backlight having been obtained through cross talk correction. An ideal data conversion process will result in a reproduction color being identical to its corresponding expression color.

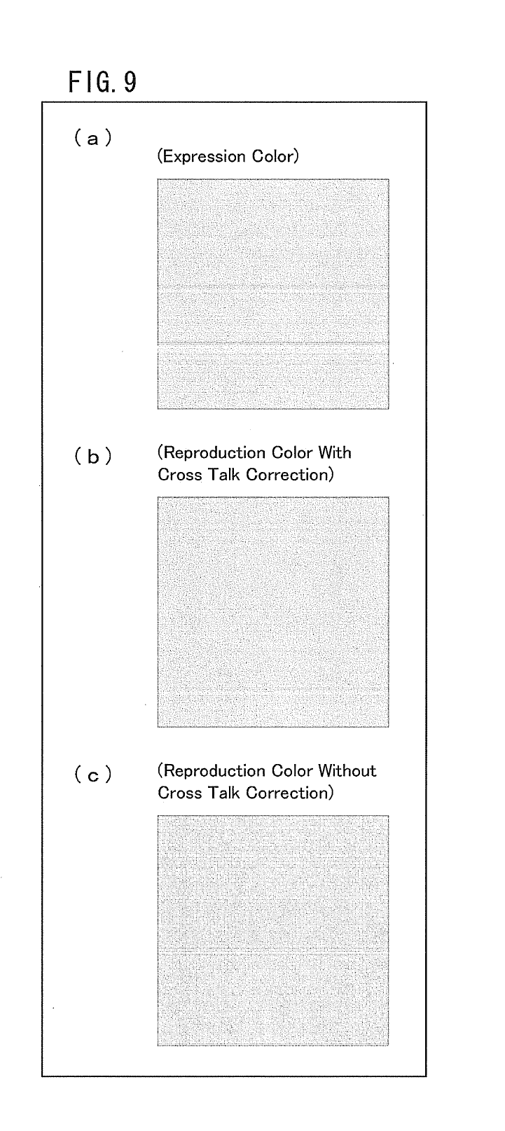

FIG. 9 illustrates an example of an expression color and a reproduction color both obtained in the case where the data conversion process illustrated in FIG. 8 has been carried out. (a) of FIG. 9 illustrates an expression color with (R, G, B)=(100, 100, 30). (b) of FIG. 9 illustrates a reproduction color obtained in the case where the data conversion process illustrated in FIG. 8 has been carried out. (c) of FIG. 9 illustrates for comparison a reproduction color obtained in the case where no data conversion process has been carried out, so that optical cross talk has occurred.

As illustrated in (c) of FIG. 9, carrying out no data conversion process results in occurrence of optical cross talk and thus in generation of a color different from the expression color (that is, occurrence of a color shift). In contrast, carrying out the data conversion process of the present embodiment enables generation of a reproduction color substantially identical to the expression color (see (b) of FIG. 9).

Although it is difficult to recognize a chromaticity difference between the monochrome images of FIG. 9, the reproduction color of (c) of FIG. 9, obtained with no data conversion process carried out, is greater in blueness and more grayish overall than the expression color of (a) of FIG. 9, and looks, to the naked eye, clearly different from (a) of FIG. 9. On the other hand, the reproduction color of (b) of FIG. 9, obtained with a data conversion process carried out, does not have as large an increase in blueness as above, and has a hue that looks, to the naked eye, substantially identical to the hue of the expression color of (a) of FIG. 9.

The respective colors of (a) through (c) of FIG. 9 are numerically expressed in gray scale values for R, G, and B as: (R, G, B)=(100, 100, 30); (R, G, B)=(100, 100, 35); and (R, G, B)=(100, 100, 45).

The liquid crystal display device 300 of the present embodiment, which carries out the above display control, carries out an aperture ratio conversion process for collectively decreasing the aperture ratios of the respective picture elements 12r, 12g, and 12b of R, G, and B, and consequently reduces light that is transmitted through a color filter corresponding to a picture element of a color which is different from the color for the wavelength of the light. Further, in order to supplement the transmittance of each pixel that transmittance has been decreased by the above aperture ratio conversion process, the liquid crystal display device 300 increases the luminance of the white LEDs 32w on the basis of backlight data as converted by the backlight data converting section 122. This arrangement makes it possible to, for example, prevent or reduce optical cross talk itself.

The display control of the present embodiment, which increases the luminance of the white LEDs 32w, increases the luminance of light that has the wavelength for blue and that is included in white light. The display control thus produces a lower effect of reducing optical cross talk than the effect produced by the liquid crystal display device of Embodiment 1, which increases only the luminance of a green-light source.

The present embodiment includes, as an example, a backlight that includes white LEDs as light sources. The display control of the present embodiment is, however, also applicable to a backlight that includes, as light sources, LEDs having the respective colors of R, G, and B. In this case, respective luminances of the light sources of the respective colors of R, G, and B are controlled at an identical rate.

### Embodiment 3

The following description deals with a third embodiment of the present invention with reference to FIGS. 2 and 10 through 12. The present invention is not limited to the present embodiment. Embodiment 3 described herein is a liquid crystal display device that can correct electrical cross talk.

FIG. 2 illustrates a cross-sectional configuration of the liquid crystal display device of the present embodiment. As illustrated in FIG. 2, the liquid crystal display device 400 of the present embodiment includes: a liquid crystal panel 3; and a backlight 2 provided behind the liquid crystal panel 3. As is clear from FIG. 2, the liquid crystal panel 3 and the backlight 2 included in the liquid crystal display device 400 are identical in configuration to those included in the liquid crystal display device 100 of Embodiment 1, and are thus not described here in detail for their individual sections.

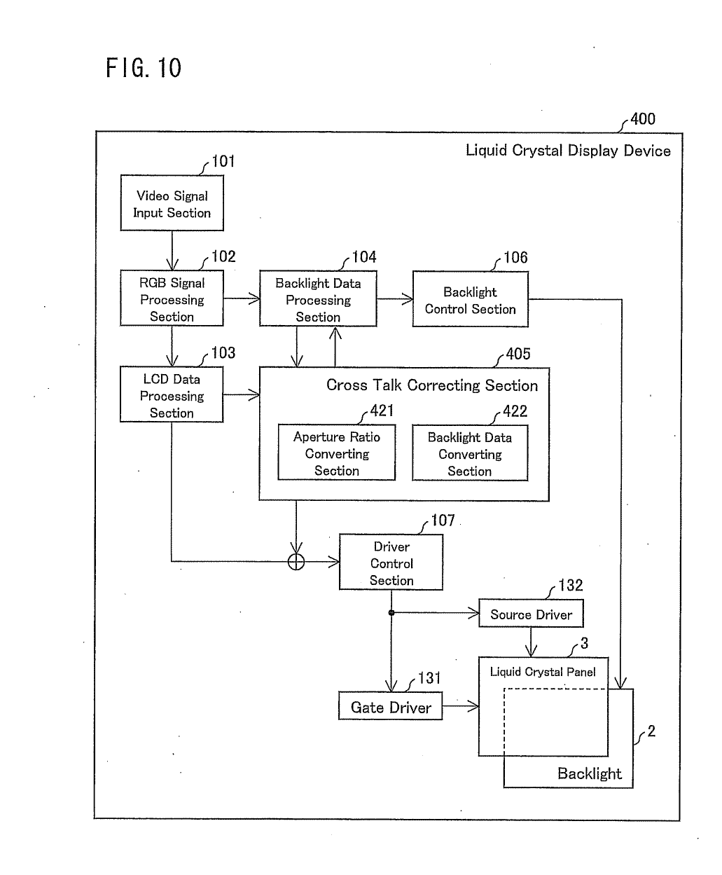

The following describes, with reference to FIG. 10, an arrangement for controlling respective operations of the liquid crystal panel 3 and the backlight 2.

As illustrated in FIG. 10, the liquid crystal display device 400 includes, for example: a video signal input section 101; an RGB signal processing section 102; an LCD data processing section 103; a backlight data processing section 104; a cross talk correcting section 105; a backlight control section 106 (backlight luminance control section); a driver control section 107; a gate driver 131; and a source driver 132. These sections and drivers are each formed by a circuit.

The video signal input section 101 receives video signals transmitted from, for example, a TV receiver, a VTR, or a DVD, and transmits those video signals to the RGB signal processing section 102.

The RGB signal processing section 102 generates, on the basis of the video signals transmitted thereto, image data to be transmitted to the picture elements. In the present embodiment, the RGB signal processing section 102 generates R image data, G image data, and B image data as image data to be transmitted to the picture elements having the respective colors of R, G, and B. The RGB signal processing section 102 transmits the image data, generated as above, to the LCD data processing section 103 and the backlight data processing section 104.

The LCD data processing section 103 carries out, on the basis of the image data transmitted thereto, a data processing so that the liquid crystal panel will display a target image.

The backlight data processing section 104 determines backlight output values on the basis of the image data transmitted from the RGB signal processing section 102.

The cross talk correcting section 405 serves to reduce electrical cross talk occurring due to a gray scale difference between adjacent ones of R, G, and B picture elements constituting a pixel. The cross talk correcting section 405 thus includes: an aperture ratio converting section 421 for converting the aperture ratios of the respective picture elements for image data transmitted to the liquid crystal panel 3; and a backlight data converting section 422 (backlight luminance control section) for converting backlight data.

The aperture ratio converting section 421 carries out, with respect to image data that corresponds to the respective colors of R, G, and B and that has been transmitted from the LCD data processing section 103, an aperture ratio conversion process for reducing a gray scale difference between the picture elements in a pixel. This process for reducing a gray scale difference is, for example, a threshold processing or a process involving a calculation formula.

The backlight data converting section 422 carries out a process of converting luminance data for light sources for the respective colors of R, G, and B to compensate for a luminance variation caused in the picture elements by the aperture ratio conversion carried out by the aperture ratio converting section 421.

Specifically, in order to correct a gray scale difference between the picture elements which gray scale difference has been reduced by the aperture ratio converting section 421, the backlight data converting section 422 carries out a backlight data conversion process that (i) increases, over the luminance of a light source for a color identical to the color of a picture element of which the aperture ratio has not been changed by the aperture ratio converting section 421, the luminance of a light source for a color identical to the color of a picture element of which the aperture ratio has been reduced by the aperture ratio converting section 421, and that (ii) decrease, against the luminance of a light source for a color identical to the color of a picture element of which the aperture ratio has not been changed by the aperture ratio converting section 421, the luminance of a light source for a color identical to the color of a picture element of which the aperture ratio has been increased by the aperture ratio converting section 421.

The following describes a specific example of an aperture ratio conversion process carried out to cancel electrical cross talk.

In the case where, for example, (i) expressing a gray scale value for image data requires the luminances (expression color) of (R, G, B)=(100, 100, 30) and (ii) the backlight luminances have been set by the backlight data processing section 104 to (R, G, B)=(100, 100, 100), the aperture ratios for the LCD are (R, G, B)=(100, 100, 30). This gray scale difference between the R, G, and B picture elements causes electrical cross talk. Under such a condition, the aperture ratio converting section 421 carries out a conversion process for reducing the gray scale difference between the picture elements.

The following describes, as an example of the above conversion process, an example process based on the difference between the R, G, and B picture elements, more specifically an example conversion process for, in the case where the difference has a value of greater than 40, increasing an aperture ratio for the LCD so that the difference has a value of 40.

The aperture ratio converting section 421 converts the aperture ratios for the LCD from (R, G, B)=(100, 100, 30) to (100, 100, 60). Since the aperture ratio converting section 421 has thus doubled the aperture ratio for B, the backlight data converting section 422 halves the luminance for B to convert the aperture ratios for the LCD from (R, G, B)=(100, 100, 100) to (100, 100, 50).

The following describes, as another example, an example conversion process for, in the case where the difference has a value of greater than 20, decreasing an aperture ratio for the LCD so that the difference has a value of 20.

The aperture ratio converting section 421 converts the aperture ratios for the LCD from (R, G, B)=(100, 100, 30) to (50, 50, 30). Since the aperture ratio converting section 421 has thus halved the aperture ratios for R and G, the backlight data converting section 422 doubles the luminance for B to convert the aperture ratios for the LCD from (R, G, B)=(100, 100, 100) to (200, 200, 100).

Specific examples of an applicable method for the above process include various methods such as a threshold processing and a formula. It is, however, preferable to carry out a process of converting aperture ratios of the respective picture elements on the basis of the difference between R, G, and B picture elements as described above.

The backlight control section 106 controls, on the basis of the backlight data transmitted from the backlight data processing section 104, respective luminances of the light sources having the respective colors of R, G, and B. The backlight control section 106 receives backlight data including data obtained through the conversion carried out by the backlight data converting section 422 included in the cross talk correcting section.

The driver control section 107 controls the gate driver 131 and the source driver 132 on the basis of (i) data transmitted from the LCD data processing section 103 and (ii) data transmitted from the aperture ratio converting section 421 included in the cross talk correcting section 405.

The gate driver 131 is connected to scanning signal lines included in the liquid crystal panel 3, and supplies scanning signals to the scanning signal lines.

The source driver 132 is connected to data signal lines included in the liquid crystal panel 3, and supplies data signals to the data signal lines. The aperture ratio data as converted by the aperture ratio converting section 421 is transmitted to the individual picture elements 12 via the source driver 132 and the data signal lines. The picture elements 12 carry out a display on the basis of the aperture ratio data thus transmitted.

The following describes an example of a method for controlling image display carried out by the liquid crystal display device 400 of the present embodiment.

The description below uses the expression (R, G, B)=(100, 100, 30) to collectively refer to any case where luminances of, for example, 100, 100, and 30 are necessary to express image data having gray scale values corresponding to picture elements 12r, 12g, and 12b constituting a pixel 31 in the liquid crystal panel 3. Further, the description below uses the expression (R, G, B)=(100, 100, 30) to collectively refer to any case where luminances of backlight data which luminances correspond to light sources having the respective colors of R, G, and B are, for example, 100, 100, and 30. The brightness (luminance) of a picture element can be expressed in the form of the aperture ratio of the picture element, and is expressed as a number within the range from 0 to 100 in the present embodiment.

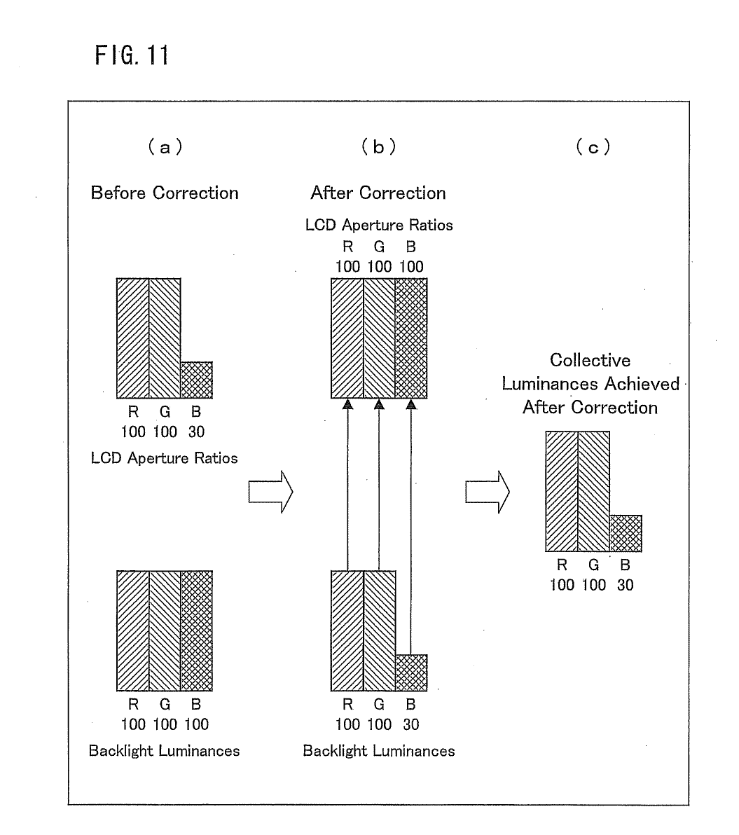

FIG. 11 illustrates an example of how conversion is carried out with respect to image data and backlight data for the picture elements 12r, 12g, and 12b constituting a pixel 31 in the liquid crystal panel 3.

(a) of FIG. 11 illustrates example aperture ratios of the respective picture elements 12r, 12g, and 12b constituting a pixel 31 in the liquid crystal panel (LCD) 3, the aperture ratios being observed before cross talk correction. These pieces of image data have been generated by the LCD data processing section 103 on the basis of data transmitted from the ROB signal processing section 102. (a) of FIG. 11 further illustrates luminance data for the respective light sources for R, G, and B in the backlight. This luminance data has been generated by the backlight data processing section 104 on the basis of data transmitted from the RGB signal processing section 102. The description herein uses the term “expression color” to refer to a pixel color expressed by combining (i) the aperture ratios of the respective picture elements for image data in (a) of FIG. 11 with (ii) the backlight luminances.

(b) of FIG. 11 illustrates (i) image data obtained through conversion, by the aperture ratio converting section 421 and the backlight data converting section 422 both included in the cross talk correcting section 405, of image data corresponding to the image data of (a), and (ii) backlight data.

As illustrated in (b) of FIG. 11, the aperture ratios of the LCD are converted from (100, 100, 30) to (100, 100, 100) through a process by the aperture ratio converting section 421. The backlight luminances are, on the other hand, converted from (100, 100, 100) to (100, 100, 30) through a process by the backlight data converting section 422.

The data of the aperture ratios of the LCD, the data having been obtained through the conversion by the aperture ratio converting section 421, is then transmitted to the driver control section 107 along with image data generated by the LCD data processing section 103. The driver control section 107 generates, on the basis of the image data thus transmitted thereto, various signals to be transmitted to the gate driver 131 and the source driver 132.

The luminance data obtained through the conversion by the backlight data converting section 422 is transmitted back to the backlight data processing section 104. The backlight data processing section 104 carries out a data processing on the basis of the luminance data transmitted thereto, and transmits the processed luminance data to the backlight control section 106 for driving the backlight 2.

(c) of FIG. 11 illustrates collective luminances obtained by combining image data for the picture elements with backlight luminances, the image data and the backlight luminances both having been obtained through cross talk correction by the cross talk correcting section 405. The description herein uses the term “reproduction color” to refer to a pixel color expressed by combining (i) aperture ratios of the respective picture elements with (ii) backlight luminances, the aperture ratios and the backlight luminances having been obtained through cross talk correction. An ideal data conversion process will result in a reproduction color being identical to its corresponding expression color.

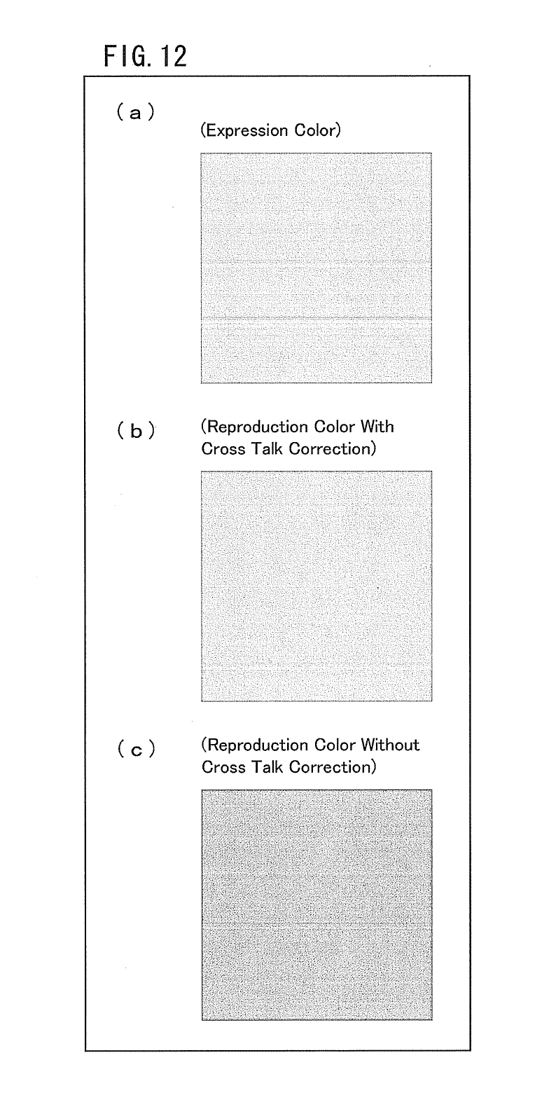

FIG. 12 illustrates an example of an expression color and a reproduction color both obtained in the case where the data conversion process illustrated in FIG. 11 has been carried out. (a) of FIG. 12 illustrates an expression color with (R, G, B)=(100, 100, 30). (b) of FIG. 12 illustrates a reproduction color obtained in the case where the data conversion process illustrated in FIG. 11 has been carried out. (c) of FIG. 12 illustrates for comparison a reproduction color obtained in the case where no data conversion process has been carried out, so that electrical cross talk has occurred.

As illustrated in (c) of FIG. 12, carrying out no data conversion process results in occurrence of electrical cross talk and thus in generation of a color different from the expression color (that is, occurrence of a color shift). In contrast, carrying out the data conversion process of the present embodiment enables generation of a reproduction color substantially identical to the expression color (see (b) of FIG. 12).

Although it is difficult to recognize a chromaticity difference between the monochrome images of FIG. 12, the reproduction color of (c) of FIG. 12, obtained with no data conversion process carried out, is smaller in greenness and more reddish overall than the expression color of (a) of FIG. 12, and looks, to the naked eye, clearly different from (a) of FIG. 12. On the other hand, the reproduction color of (b) of FIG. 12, obtained with a data conversion process carried out, does not have as large an increase in greenness as above, and has a hue that looks, to the naked eye, substantially identical to the hue of the expression color of (a) of FIG. 12.

The respective colors of (a) through (c) of FIG. 12 are numerically expressed in gray scale values for R, G, and B as: (R, G, B)=(100, 100, 30); (R, G, B)=(100, 100, 30); and (R, G, B)=(100, 85, 30).

The liquid crystal display device 400 of the present embodiment, which carries out the above display control, prevents or reduces electrical cross talk itself.

FIG. 11 illustrates only an example of converting aperture ratios for the LCD in the case where the aperture ratios for original image data are (100, 100, 30). For image data for other pixels, it is simply necessary to carry out a conversion to multiply the aperture ratio of the G picture element by 10/3 in response to the multiplication of the luminance of the B light source by 3/10. In the case where, for example, expressing gray scale values for original image data requires the luminance values (aperture ratios) of (R, G, B)=(50, 20, 15), since the backlight luminances have been converted from (100, 100, 100) to (100, 100, 30), the aperture ratios of the respective picture elements are converted from (50, 20, 15) to (50, 20, 50).

The above description indicates that in the case where the aperture ratios for all pixels are to be converted, a conversion process is preferably carried out through the flow described below.

First, the RGB signal processing section 102 calculates, for example, (i) respective average gray scale values (more specifically, average aperture ratios) for R, G, and B and (ii) respective maximum gray scale values (more specifically, maximum aperture ratios) for R, G, and B on the basis of input data. The RGB signal processing section 102 thus determines how to convert backlight luminances.

In the case where, for example, expressing average gray scale values for R, G, and B requires the luminance values (that is, average aperture ratios) of (R, G, B)=(100, 100, 30), since G is higher in value than B, a predictable tendency is that there likely occurs a gray scale difference between G and B. Thus, the backlight data converting section 422 carries out a process of, for example, increasing the value of G or decreasing the value of B. In the case where the backlight data converting section 422 has increased the value of G, the aperture ratio converting section 421 decreases the aperture ratio of G, so that the gray scale difference between G and B decreases. In the case where the backlight data converting section 422 has decreased the value of B, the aperture ratio converting section 421 increases the aperture ratio of B, so that the gray scale difference between G and B decreases.

In the case where, for example, the value of G is doubled, the backlight luminances are converted from (100, 100, 100) to (100, 200, 100). The aperture ratio converting section 421 then carries out a conversion process for halving the aperture ratio of the G picture element.

In the case where an aperture ratio conversion is to be carried out for all pixels, the rate of such an aperture ratio conversion for the picture elements can be determined on the basis of the above-described difference between the R, G, and B picture elements.

In the case where expressing average gray scale values for R, G, and B requires the luminance values (that is, average aperture ratios) of (R, G, B)=(100, 100, 30), since the difference between (i) either of R and G and (ii) B has a value of greater than 40, it is necessary that the aperture ratio converting section 421 carry out a process for doubling the aperture ratio of B so that the difference has a value of 40. The backlight data converting section 422, in response, halves the luminance of B to convert the backlight luminances from (R, G, B)=(100, 100, 100) to (100, 100, 50). The aperture ratio converting section 421 then carries out a conversion process for doubling the aperture ratio of B for each pixel.

With the arrangement of, as described above, emitting backlight having a luminance that is uniform over a region in which a plurality of pixels are provided, it is preferable that the backlight data converting section 422 first carry out its process before the aperture ratio converting section 421 carries out a conversion process for the aperture ratios of the respective picture elements. This arrangement advantageously optimizes the conversion process. This is for the following reason: Even in the case where it is possible to convert respective aperture ratios for individual picture elements, first determining data for backlight, which is uniform, makes it easier to determine the aperture ratios of the respective picture elements.

### Variation of Embodiment 3

The backlight 2 of the above liquid crystal display device 400 is capable of individually controlling the respective luminances of light sources of the respective colors of R, G, and B, and emits light having a luminance that is uniform over the entire light-emitting surface of the backlight 2. The present invention is also applicable to a liquid crystal display device including an area active drive backlight, the liquid crystal display device being capable of individually controlling respective luminances of a plurality of divisional light-emitting regions, into which the light-emitting surface of the backlight is divided.

The following describes (i) a configuration of a liquid crystal display device including such an area active drive backlight and (ii) a method for controlling display of that liquid crystal display device. No description is provided here of (i) members of the liquid crystal display device of the present variation which members are identical to their respective corresponding members of the liquid crystal display device 400 and (ii) portions of the method of the present variation which portions are identical to their respective corresponding portions of the method for controlling display of the liquid crystal display device 400.

FIG. 5 illustrates a liquid crystal display device 500 including an area active drive backlight 202.

As illustrated in FIG. 5, the liquid crystal display device 500 includes: a liquid crystal panel 203; and a backlight 202 provided behind the liquid crystal panel 203. As is clear from FIG. 5, the liquid crystal panel 203 and the backlight 202 included in the liquid crystal display device 500 are identical in configuration to those included in the liquid crystal display device 200 of the variation of Embodiment 1, and are thus not described here in detail for their individual sections.

The following describes a method for carrying out an area active drive in the liquid crystal display device 500. How the liquid crystal display device 500 is operated can be controlled with use of a configuration similar to that illustrated in FIG. 10. The description below thus refers to FIG. 10.

First, as in Embodiment 3, the RGB signal processing section 102 generates image data for the individual picture elements on the basis of video signals transmitted thereto, and transmits the image data to the backlight data processing section 104. The backlight data processing section 104 detects from the image data transmitted thereto a maximum gray scale in all picture elements of R, G, and B for each divisional display region R of the liquid crystal panel 203 (regardless of the color). The backlight data processing section 104 then determines, on the basis of the maximum gray scale thus detected, backlight data for the divisional light-emitting region D corresponding to the divisional display region R.

The above-determined backlight data for each region D is transmitted to the LCD data processing section 103 via the RGB signal processing section 102. The LCD data processing section 103 converts data for the individual picture elements on the basis of image data for the picture elements and the backlight data both transmitted to the LCD data processing section 103.

The following describes a specific example of the case in which (i) the liquid crystal panel 203 has an image display surface that is divided into a plurality of divisional display regions R1, R2, . . . in each of which two pixels 31 and 31 are provided, and (ii) the backlight 202 has a light-emitting surface that is divided into a plurality of divisional light-emitting regions D1, D2, . . . corresponding to the respective divisional display regions.

The description below assumes an example in which (i) luminances (corresponding to an expression color) for expressing gray scale values for original image data for a pixel A in R1, which is one of the two pixels in R1, are (R, G, B)=(100, 0, 50), and (ii) luminances (corresponding to an expression color) expressing gray scale values for original image data for a pixel B in R1, which is the other of the two pixels in R1, are (R, G, B)=(0, 100, 50).

In this case, a combination of maximum aperture ratios of the picture elements of the respective colors of R, G, and B in the region R1 is (R, G, B)=(100, 100, 50). The backlight data processing section 104 thus sets luminance data for light sources of the respective colors R, G, and B in the region D1 to (R, G, B)=(100, 100, 50) on the basis of the above combination of maximum aperture ratios.

The LCD data processing section 103, since input image data for the pixel A in the region R1 corresponding to the region D1 indicates (R, G, B)=(100, 0, 50), then sets output image data to (R, G, B)=(100, 0, 100) by reflecting the above backlight data processing. The LCD data processing section 103, since input image data for the pixel B in the region R1 corresponding to the region D1 indicates (R, G, B)=(0, 100, 50), sets output image data to (R, G, B)=(0, 100, 100) to reflect the above backlight data processing.

The LCD data processing section 103 can carry out the above data conversion process in accordance with, for example, (Formula 2) below for each of the colors R, G, and B:

Luminance (aperture ratio) necessary to express a gray scale value in output image data=[Luminance (aperture ratio) necessary to express a gray scale value in input image data]/(Luminance data)×100 (Formula 2)

The above method enables an area active drive of controlling backlight luminances and image data for the liquid crystal panel for each individual one of a plurality of regions into which an image display surface is divided.

The method of the present invention for an area active drive is not limited to the method described above, and can be a publicly known method such as a method disclosed in Patent Literature 3.

The image data and luminance data, which have been subjected to the above conversion process for each divisional region, are transmitted to the cross talk correcting section 405. The cross talk correcting section 405 then converts aperture ratios and luminance data as described below, for example.

In the case where luminance data for the region D1 corresponding to the region R1 has been converted as described above on the basis of the maximum aperture ratios of the picture elements of the respective colors of R, G, and B for the region R1, the expression colors and aperture ratios of the respective pixels A and B and the backlight luminances before cross talk correction are as follows:

Expression color of pixel A (R, G, B)=(100, 0, 50)

Expression color of pixel B (R, G, B)=(0, 100, 50)

Backlight luminances (R, G, B)=(100, 100, 50)

Aperture ratios of pixel A (R, G, B)=(100, 0, 100)

Aperture ratios of pixel B (R, G, B)=(0, 100, 100)

In this case, electrical cross talk occurs due to (i) respective gray scale differences between R and G and between G and B in the pixel A and (ii) a gray scale difference between R and G in the pixel B.

This problem can be solved by, for example, a method in which the backlight data converting section 422 carries out a correction to double all backlight luminances, and further, the aperture ratio converting section 421 carries out a correction to halve respective aperture ratios of all picture elements in the region R1.

This method causes the backlight luminances to change from (R, G, B)=(100, 100, 50) to (200, 200, 100) and the aperture ratios of the respective pixels A and B to be as follows:

Aperture ratios of pixel A (R, G, B)=(50, 0, 50)

Aperture ratios of pixel B (R, G, B)=(0, 50, 50)

A process such as this reduces the gray scale differences as compared to those before cross talk correction.

### Embodiment 4

The following description deals with a fourth embodiment of the present invention. The present embodiment described below is a liquid crystal display device that reduces both optical cross talk and electrical cross talk.

FIG. 2 illustrates a cross-sectional configuration of the liquid crystal display device of the present embodiment. As illustrated in FIG. 2, the liquid crystal display device 600 of the present embodiment includes: a liquid crystal panel 3; and a backlight 2 provided behind the liquid crystal panel 3. As is clear from FIG. 2, the liquid crystal panel 3 and the backlight 2 included in the liquid crystal display device 600 are identical in configuration to those included in the liquid crystal display device 100 of Embodiment 1, and are thus not described here in detail for their individual sections.

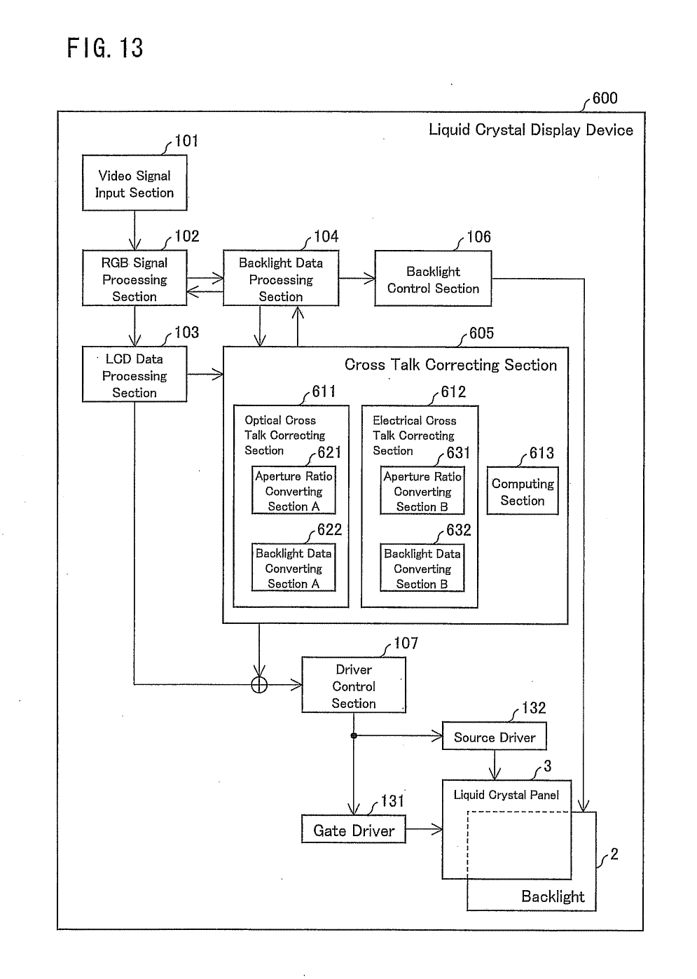

The following describes, with reference to FIG. 13, an arrangement for controlling respective operations of the liquid crystal panel 3 and the backlight 2.

As illustrated in FIG. 13, the liquid crystal display device 600 includes, for example: a video signal input section 101; an RGB signal processing section 102; an LCD data processing section 103; a backlight data processing section 104; a cross talk correcting section 605; a backlight control section 106 (backlight luminance control section); a driver control section 107; a gate driver 131; and a source driver 132. These sections and drivers are each formed by a circuit.

The video signal input section 101 receives video signals transmitted from, for example, a TV receiver, a VTR, or a DVD, and transmits those video signals to the RGB signal processing section 102.

The RGB signal processing section 102 generates, on the basis of the video signals transmitted thereto, image data to be transmitted to the picture elements. In the present embodiment, the RGB signal processing section 102 generates R image data, G image data, and B image data as image data to be transmitted to the picture elements having the respective colors of R, G, and B. The RGB signal processing section 102 transmits the image data, generated as above, to the LCD data processing section 103 and the backlight data processing section 104.

The LCD data processing section 103 carries out, on the basis of the image data transmitted thereto, a data processing so that the liquid crystal panel will display a target image.

The backlight data processing section 104 determines backlight output values on the basis of the image data transmitted from the RGB signal processing section 102.

The cross talk correcting section 605 corrects both optical cross talk and electrical cross talk. The cross talk correcting section 605 includes: an optical cross talk correcting section 611 for correcting optical cross talk; and an electrical cross talk correcting section 612 for correcting electrical cross talk. The cross talk correcting section 605 further includes a computing section 613 for carrying out a control based on a combination of respective predetermined proportions of a correction of optical cross talk and a correction of electrical cross talk.

The optical cross talk correcting section 611 serves to reduce optical cross talk occurring due to a relation between (i) respective properties of color filters provided in the liquid crystal panel 3 and (ii) respective aperture ratios (transmittances) of the picture elements. The optical cross talk correcting section 611 thus includes: an aperture ratio converting section A 621 for converting the aperture ratios of the respective picture elements for image data transmitted to the liquid crystal panel 3; and a backlight data converting section A 622 (backlight luminance control section) for converting backlight data. These two sections carry out their respective processes similar to the respective processes carried out by the aperture ratio converting section 121 and the backlight data converting section 122 both illustrated in FIG. 1.

The electrical cross talk correcting section 612 serves to reduce electrical cross talk occurring due to a gray scale difference between adjacent ones of R, G, and B picture elements constituting a pixel. The electrical cross talk correcting section 612 thus includes: an aperture ratio converting section B 631 (second aperture ratio converting section) for converting the aperture ratios of the respective picture elements for image data transmitted to the liquid crystal panel 3; and a backlight data converting section B 632 (second backlight luminance control section) for converting backlight data. These two sections carry out their respective processes similar to the respective processes carried out by the aperture ratio converting section 421 and the backlight data converting section 422 both illustrated in FIG. 10.

The computing section 613 determines a final correction amount on the basis of results of respective cross talk corrections carried out by the optical cross talk correcting section 611 and the electrical cross talk correcting section 612. The present embodiment determines a final correction amount on the basis of predetermined proportions for the respective cross talk corrections.

The following describes an example computing process carried out in (i) the case where the optical cross talk correcting section 611 converts backlight luminances from (100, 100, 100) to (100, 200, 100) as illustrated in FIG. 3 and in (ii) the case where the electrical cross talk correcting section 612 converts backlight luminances from (100, 100, 100) to (100, 100, 30) as illustrated in FIG. 11. In this case, the control proportions are 80% for a correction of optical cross talk and 20% for a correction of electrical cross talk. These control proportions may be varied as appropriate according to each case.

In this case, the computing section 613 outputs backlight luminance data calculated in accordance with the following formula:

Output luminance data (R, G, B)=[luminance data from the optical cross talk correcting section]×0.8+[luminance data from the electrical cross talk correcting section]×0.2

The above values are substituted in this formula as follow:

Output luminance data (R, G, B)=(100, 200, 100)×0.8+(100, 100, 30)×0.2=(100, 180, 86)

The computing section 613 thus outputs backlight luminance data of (R, G, B)=(100, 180, 86). Aperture ratios for LCD image data are calculated in accordance with a formula similar to the above.

After the process described above has been carried out, the data of the aperture ratios of the LCD which data has been outputted from the cross talk correcting section 605 is then transmitted to the driver control section 107 along with image data generated by the LCD data processing section 103. The driver control section 107 generates, on the basis of the image data thus transmitted thereto, various signals to be transmitted to the gate driver 131 and the source driver 132.

The luminance data outputted from the cross talk correcting section 605 is transmitted back to the backlight data processing section 104. The backlight data processing section 104 carries out a data processing on the basis of the luminance data transmitted thereto, and transmits the processed luminance data to the backlight control section 106 for driving the backlight 2.

The present embodiment, which carries out the above display control, can carry out a cross talk correction in consideration of both optical cross talk and electrical cross talk. This display control method in consideration of both optical cross talk and electrical cross talk is used in the case where, for example, there is a trade-off between optical cross talk and electrical cross talk, so that correcting optical cross talk will increase a gray scale difference between picture elements and will undesirably increase electrical cross talk as a result. In such a case, carrying out corrections for both optical cross talk and electrical cross talk at their respective proportions allows a reproduction color to be closer to an intended gray scale display (that is, an expression color), and thus makes it possible to carry out an optimal image display.

The above-described embodiment is an example that carries out respective corrections of optical cross talk and electrical cross talk at their respective predetermined proportions. The present invention is, however, not limited to such an arrangement. Another possible method is that in, e.g., a liquid crystal display device including an area active drive backlight, either a correction of optical cross talk or a correction of electrical cross talk is selected for each divisional light-emitting region so that a cross talk correction is carried out for each individual light-emitting region. Various methods other than this can be used to work the present invention.

As described above, the present invention also encompasses a liquid crystal display device including both an optical cross talk correcting section for correcting optical cross talk and an electrical cross talk correcting section for correcting electrical cross talk. The present invention further encompasses a display control method that selectively carries out, according to each case, a cross talk correction by the optical cross talk correcting section or a cross talk correction by the electrical cross talk correcting section.

In order to solve the above problems, a liquid crystal display device of the present invention includes: a liquid crystal panel including pixels arranged in a matrix; and a backlight that irradiates the liquid crystal panel with light, the pixels each including a plurality of picture elements that are different from one another in color, the picture elements each being provided with a color filter corresponding to a color of the picture element, the liquid crystal display device further comprising: an aperture ratio converting section that, in order to reduce light which has a wavelength of a color different from the color of the picture element and which is transmitted through the color filter with which the picture element is provided, decreases an aperture ratio of a picture element, the aperture ratio being included in inputted image data, and outputs data of the decreased aperture ratio; and a backlight luminance control section that, in order to supplement the aperture ratio decreased by the aperture ratio converting section, increases a backlight luminance as compared to a case in which the aperture ratio is not decreased, the liquid crystal display device carrying out an intended gray scale display on a basis of (i) backlight luminances determined by the backlight luminance control section and (ii) aperture ratios of the respective picture elements in the liquid crystal panel, said aperture ratios having been obtained through an aperture ratio conversion process by the aperture ratio converting section.

The liquid crystal display device of the present invention includes: a liquid crystal panel including pixels arranged in a matrix; and a backlight that irradiates the liquid crystal panel with light. The pixels each include a plurality of picture elements that are different from each other in color. This means that one pixel is made up of picture elements having a plurality of colors. The picture elements, each serving as a part of a pixel, are called sub-pixels as well.

The liquid crystal display device of the present invention includes an aperture ratio converting section that, in order to reduce light which has a wavelength of a color different from the color of the picture element and which is transmitted through the color filter with which the picture element is provided, decreases an aperture ratio of a picture element for inputted image data and outputs data of the decreased aperture ratio. The aperture ratio converting section decreases an aperture ratio for inputted image data and outputs data of the aperture ratio, which has a value decreased from the inputted value. This arrangement reduces the amount of optical cross talk occurring due, for example, to light that is within a wavelength range of blue and that leaks out of a green color filter.

The liquid crystal display device of the present invention further includes a backlight luminance control section that increases a backlight luminance in order to compensate for a change in a display gray scale of each picture element which change is caused by the above aperture ratio conversion process. The liquid crystal display device carries out an intended gray scale display on the basis of (i) backlight luminances determined by the backlight luminance control section and (ii) aperture ratios of the respective picture elements in the liquid crystal panel, the aperture ratios having been obtained through the aperture ratio conversion process by the aperture ratio converting section.

In other words, the liquid crystal display device of the present invention causes the aperture ratio converting section to process image data, transmitted to the liquid crystal panel, so as to reduce the amount of optical cross talk, and changes a backlight luminance to compensate for a shift from an intended gray scale in image data which shift occurs due to the above aperture ratio conversion process.

The above arrangement prevents the occurrence of or reduces the amount of optical cross talk itself. The above arrangement can thus reduce cross talk more effectively than a conventional method for canceling optical cross talk with use of only a driving circuit in the liquid crystal panel. As such, it is possible to prevent a decrease in display quality which decrease is caused by optical cross talk. Further, the present invention can be worked with use of a circuit configuration simpler than in a conventional method for canceling optical cross talk.

The liquid crystal display device of the present invention may be arranged such that the backlight includes light sources having respective colors that correspond to picture elements having a plurality of colors; the aperture ratio converting section decreases an aperture ratio, included in image data, of a picture element among said picture elements having the plurality of colors and constituting a pixel, which picture element is provided with a first color filter that transmits an amount of light having a color other than a color of the picture element provided with the first color filter, the amount being greater than for any other color filter; and the backlight luminance control section increases, over a luminance of a light source of any other color, a luminance of a light source having a color corresponding to the color of the picture element provided with a first color filter of which picture element the aperture ratio is decreased by the aperture ratio converting section.

The above arrangement makes it possible to (i) specifically increase the luminance of a light source having a color identical to the color of the picture element of which the aperture ratio is decreased and (ii) maintain, instead of increasing, the luminance of a light source having any other color. This in turn makes it possible to reduce, as compared to the case in which the backlight luminances are all increased, a large amount of light that (i) has a color other than the color of the color filter provided for the picture element of which the aperture ratio is decreased and that (ii) is transmitted through the color filter. As such, it is possible to further reduce optical cross talk. In addition, increasing the luminance of only a light source having a particular color reduces power consumption as compared to the case in which the backlight luminances are all increased.

The liquid crystal display device of the present invention may be arranged such that the pixels are each made up of a red picture element, a green picture element, and a blue picture element; the backlight includes a red light source, a green light source, and a blue light source; the aperture ratio converting section decreases an aperture ratio included in image data for the green picture element; and the backlight luminance control section increases a luminance of the green light source over respective luminances of the red light source and the blue light source.

The above arrangement reduces blue light transmitted through the color filter for the green picture element. This makes it possible to more effectively reduce optical cross talk occurring due to light that has a wavelength in the vicinity of blue and that leaks out of the green color filter.

The liquid crystal display device of the present invention may be arranged such that the backlight has a light-emitting surface that is divided into a plurality of light-emitting regions; and the backlight luminance control section carries out luminance controls different from one another for the respective divisional light-emitting regions.

The above arrangement allows the backlight to emit light with luminances different from one another for the respective light-emitting regions, into which the backlight is divided. This allows the aperture ratio converting section to carry out a more suitable aperture ratio conversion for correcting optical cross talk with respect to each of the display regions in the liquid crystal panel which correspond to the respective divisional light-emitting regions.

The liquid crystal display device of the present invention may be arranged such that the backlight includes light sources having respective colors that correspond to picture elements having a plurality of colors; the liquid crystal display device further comprises: a second aperture ratio converting section that, in order to reduce a gray scale difference between the picture elements in a pixel, converts aperture ratios, included in the inputted image data, of said picture elements in the pixel and outputs data of the converted aperture ratios; and a second backlight luminance control section that, in order to correct the gray scale difference between said picture elements in the pixel which gray scale difference has been reduced by the second aperture ratio converting section, (i) increases, over a luminance of a light source having a color identical to a color of a picture element of which an aperture ratio is not changed by the second aperture ratio converting section, a luminance of a light source having a color identical to a color of a picture element of which an aperture ratio is decreased by the second aperture ratio converting section and (ii) decreases, against the luminance of the light source having the color identical to the color of the picture element of which the aperture ratio is not changed by the second aperture ratio converting section, a luminance of a light source having a color identical to a color of a picture element of which an aperture ratio is increased by the second aperture ratio converting section; and the liquid crystal display device causes the aperture ratio converting section, the backlight luminance control section, and at least one of the second aperture ratio converting section and the second backlight luminance control section to convert the aperture ratios of the respective picture elements in the liquid crystal panel and control the backlight luminances.

According to the above arrangement, the aperture ratio converting section and the backlight luminance control section make it possible to correct optical cross talk, and additionally, the second aperture ratio converting section and the second backlight luminance control section make it possible to correct electrical cross talk.

Further, the above arrangement allows an intended cross talk correction to be carried out by selecting, in accordance with each case, (i) the combination of the aperture ratio converting section and the backlight luminance control section or (ii) the combination of the second aperture ratio converting section and the second backlight luminance control section.

In order to solve the above problems, a liquid crystal display device of the present invention includes: a liquid crystal panel including pixels arranged in a matrix; and a backlight that irradiates the liquid crystal panel with light, the pixels each including a plurality of picture elements that are different from one another in color, the picture elements each being provided with a color filter corresponding to a color of the picture element, the backlight including light sources having respective colors that correspond to picture elements having a plurality of colors, the liquid crystal display device further comprising: an aperture ratio converting section that, in order to reduce a gray scale difference between the picture elements in a pixel, converts aperture ratios, included in inputted image data, of said picture elements in the pixel and outputs data of the converted aperture ratios; and a backlight luminance control section that, in order to correct the gray scale difference between said picture elements in the pixel which gray scale difference has been reduced by the aperture ratio converting section, (i) increases, over a luminance of a light source having a color identical to a color of a picture element of which an aperture ratio is not changed by the aperture ratio converting section, a luminance of a light source having a color identical to a color of a picture element of which an aperture ratio is decreased by the aperture ratio converting section and (ii) decreases, against the luminance of the light source having the color identical to the color of the picture element of which the aperture ratio is not changed by the aperture ratio converting section, a luminance of a light source having a color identical to a color of a picture element of which an aperture ratio is increased by the aperture ratio converting section, the liquid crystal display device carrying out an intended gray scale display on a basis of (i) backlight luminances determined by the backlight luminance control section and (ii) aperture ratios of the respective picture elements in the liquid crystal panel, said aperture ratios having been obtained through an aperture ratio conversion process by the aperture ratio converting section.

The liquid crystal display device of the present invention includes: a liquid crystal panel including pixels arranged in a matrix; and a backlight that irradiates the liquid crystal panel with light. The pixels each include a plurality of picture elements that are different from each other in color. This means that one pixel is made up of picture elements having a plurality of colors. The picture elements, each serving as a part of a pixel, are called sub-pixels as well. Further, the backlight includes light sources having respective colors corresponding to the respective colors of the picture elements.

The liquid crystal display device of the present invention includes an aperture ratio converting section that, in order to reduce a gray scale difference between the picture elements in a pixel, converts aperture ratios of the picture elements in the pixel for inputted image data and outputs data of the converted aperture ratios. The aperture ratio converting section reduces an aperture ratio difference (that is, a gray scale difference caused by an aperture ratio difference) between adjacent picture elements for inputted image data, and outputs data of the aperture ratio difference reduced from its inputted state. This arrangement reduces the amount of electrical cross talk occurring due to a large gray scale difference between picture elements having the respective colors and constituting a pixel.

The liquid crystal display device of the present invention further includes a backlight luminance control section that serves to compensate for a change in a display gray scale of each picture element which change is caused by the above aperture ratio conversion process. The backlight luminance control section carries out a control to (i) increase, over a luminance of a light source having a color identical to a color of a picture element of which an aperture ratio is not changed by the aperture ratio converting section, a luminance of a light source having a color identical to a color of a picture element of which an aperture ratio has been decreased by the aperture ratio converting section and (ii) decreases, against the luminance of the light source having the color identical to the color of the picture element of which the aperture ratio is not changed by the aperture ratio converting section, a luminance of a light source having a color identical to a color of a picture element of which an aperture ratio is increased by the aperture ratio converting section. The liquid crystal display device thus carries out an intended gray scale display on the basis of (i) backlight luminances determined by the backlight luminance control section and (ii) aperture ratios of the respective picture elements in the liquid crystal panel, the aperture ratios having been obtained through an aperture ratio conversion process by the aperture ratio converting section.

In other words, the liquid crystal display device of the present invention causes the aperture ratio converting section to process image data, transmitted to the liquid crystal panel, so as to reduce the amount of electrical cross talk, and changes a backlight luminance to compensate for a shift from an intended gray scale in image data which shift occurs due to the above aperture ratio conversion process.

The above arrangement prevents the occurrence of or reduces the amount of electrical cross talk itself. The above arrangement can thus reduce cross talk more effectively than a conventional method for canceling electrical cross talk with use of only a driving circuit in the liquid crystal panel. As such, it is possible to prevent a decrease in display quality which decrease is caused by electrical cross talk. Further, the present invention can be worked with use of a circuit configuration simpler than in a conventional method for canceling electrical cross talk.

The liquid crystal display device of the present invention may be arranged such that the backlight has a light-emitting surface that is divided into a plurality of light-emitting regions; and the backlight luminance control section carries out luminance controls different from one another for the respective divisional light-emitting regions.

The above arrangement allows the backlight to emit light with luminances different from one another for the respective light-emitting regions, into which the backlight is divided. This allows the aperture ratio converting section to carry out a more suitable aperture ratio conversion for correcting electrical cross talk with respect to each of the display regions in the liquid crystal panel which correspond to the respective divisional light-emitting regions.

In order to solve the above problems, a method of the present invention for controlling display of a liquid crystal display device is a method for controlling display of a liquid crystal display device including: a liquid crystal panel including pixels arranged in a matrix; and a backlight that irradiates the liquid crystal panel with light, the pixels each including a plurality of picture elements that are different from one another in color, the picture elements each being provided with a color filter corresponding to a color of the picture element, the method comprising: an aperture ratio converting step for, in order to reduce light which has a wavelength of a color different from the color of the picture element and which is transmitted through the color filter with which the picture element is provided, decreasing an aperture ratio, included in inputted image data, of a picture element and outputting data of the decreased aperture ratio; and a backlight luminance control step for, in order to supplement the aperture ratio decreased in the aperture ratio converting step, increasing a backlight luminance as compared to a case in which the aperture ratio is not decreased, the liquid crystal display device carrying out an intended gray scale display on a basis of (i) backlight luminances determined in the backlight luminance control step and (ii) aperture ratios of the respective picture elements in the liquid crystal panel, said aperture ratios having been obtained through an aperture ratio conversion process in the aperture ratio converting step.

The above method, in order to correct optical cross talk, not only converts the aperture ratios of the respective picture elements for image data, but also utilizes a control of backlight luminances. In other words, the above method causes the liquid crystal display device to carry out an intended gray scale display by so utilizing the backlight luminances as to compensate for a shift of an image display from an intended gray scale which shift occurs due to an aperture ratio conversion carried out to reduce optical cross talk.

This arrangement reduces the amount of optical cross talk itself. It follows that it is possible to reduce optical cross talk occurring due to a factor beyond prediction, and consequently to improve display quality. Further, the present invention can be worked with use of a circuit configuration simpler than in a conventional method for canceling optical cross talk.

In order to solve the above problems, a method of the present invention for controlling display of a liquid crystal display device is a method for controlling display of a liquid crystal display device including: a liquid crystal panel including pixels arranged in a matrix; and a backlight that irradiates the liquid crystal panel with light, the pixels each including a plurality of picture elements that are different from one another in color, the picture elements each being provided with a color filter corresponding to a color of the picture element, the backlight including light sources having respective colors that correspond to picture elements having a plurality of colors, the method comprising: an aperture ratio converting step for, in order to reduce a gray scale difference between the picture elements in a pixel, converting aperture ratios of said picture elements in the pixel for inputted image data and outputting data of the converted aperture ratios; and a backlight luminance control step for, in order to correct the gray scale difference between said picture elements in the pixel which gray scale difference has been reduced in the aperture ratio converting step, (i) increasing, over a luminance of a light source having a color identical to a color of a picture element of which an aperture ratio is not changed in the aperture ratio converting step, a luminance of a light source having a color identical to a color of a picture element of which an aperture ratio is decreased in the aperture ratio converting step and (ii) decreasing, against the luminance of the light source having the color identical to the color of the picture element of which the aperture ratio is not changed in the aperture ratio converting step, a luminance of a light source having a color identical to a color of a picture element of which an aperture ratio is increased in the aperture ratio converting step, the method causing the liquid crystal display device to carry out an intended gray scale display on a basis of (i) backlight luminances determined in the backlight luminance control step and (ii) aperture ratios of the respective picture elements in the liquid crystal panel, said aperture ratios having been obtained through an aperture ratio conversion process in the aperture ratio converting step.

The above method, in order to correct electrical cross talk, not only converts the aperture ratios of the respective picture elements for image data, but also utilizes a control of backlight luminances. In other words, the above method causes the liquid crystal display device to carry out an intended gray scale display by so utilizing the backlight luminances as to compensate for a shift of an image display from an intended gray scale which shift occurs due to an aperture ratio conversion carried out to reduce electrical cross talk.

This arrangement reduces the amount of electrical cross talk itself. It follows that it is possible to reduce electrical cross talk occurring due to a factor beyond prediction, and consequently to improve display quality. Further, the present invention can be worked with use of a circuit configuration simpler than in a conventional method for canceling electrical cross talk.

The present invention is not limited to the description of the embodiments above, but may be altered in various ways by a skilled person within the scope of the claims. Any embodiment based on a proper combination of technical means altered within the scope of the claims or technical means described in the embodiments is also encompassed in the technical scope of the present invention.

### INDUSTRIAL APPLICABILITY

The liquid crystal display device of the present invention prevents or reduces cross talk to improve display quality.

### REFERENCE SIGNS LIST

2 backlight
3 liquid crystal panel
11 active matrix substrate
12 picture element (picture element electrode)
12r, 12g, 12b picture elements of R, G, and B
13 liquid crystal layer
14 counter substrate
22 color filter layer
22r, 22g, 22b color filters section
31 pixel
32r, 32g, and 32b LEDs (light sources)
100 liquid crystal display device
104 backlight data processing section
105 cross talk correcting section
106 backlight control section (backlight luminance control section)
121 aperture ratio converting section
122 backlight data converting section (backlight luminance control section)
200 liquid crystal display device
202 backlight
203 liquid crystal panel
300 liquid crystal display device
302 backlight
400 liquid crystal display device
405 cross talk correcting section
421 aperture ratio converting section
422 backlight data converting section (backlight luminance control section)
500 liquid crystal display device
600 liquid crystal display device
605 cross talk correcting section
611 optical cross talk correcting section
612 electrical cross talk correcting section
613 computing section
621 aperture ratio converting section A
622 backlight data converting section A (backlight luminance control section)
631 aperture ratio converting section B
632 backlight data converting section B (backlight luminance control section)
D divisional light-emitting region
R divisional display region

1. A liquid crystal display device, comprising:
a liquid crystal panel including pixels arranged in a matrix; and
a backlight that irradiates the liquid crystal panel with light,
the pixels each including a plurality of picture elements that are different from one another in color,
the picture elements each being provided with a color filter corresponding to a color of the picture element,
the liquid crystal display device further comprising:
an aperture ratio converting section that, in order to reduce light which has a wavelength of a color different from the color of the picture element and which is transmitted through the color filter with which the picture element is provided, decreases an aperture ratio of a picture element, the aperture ratio being included in inputted image data, and outputs data of the decreased aperture ratio; and
a backlight luminance control section that, in order to supplement the aperture ratio decreased by the aperture ratio converting section, increases a backlight luminance as compared to a case in which the aperture ratio is not decreased,
the liquid crystal display device carrying out an intended gray scale display on a basis of (i) backlight luminances determined by the backlight luminance control section and (ii) aperture ratios of the respective picture elements in the liquid crystal panel, said aperture ratios having been obtained through an aperture ratio conversion process by the aperture ratio converting section.

2. The liquid crystal display device according to claim 1,
wherein:
the backlight includes light sources having respective colors that correspond to picture elements having a plurality of colors;
the aperture ratio converting section decreases an aperture ratio, included in image data, of a picture element among said picture elements having the plurality of colors and constituting a pixel, which picture element is provided with a first color filter that transmits an amount of light having a color other than a color of the picture element provided with the first color filter, the amount being greater than for any other color filter; and
the backlight luminance control section increases, over a luminance of a light source of any other color, a luminance of a light source having a color corresponding to the color of the picture element provided with a first color filter of which picture element the aperture ratio is decreased by the aperture ratio converting section.

3. The liquid crystal display device according to claim 2,
wherein:
the pixels are each made up of a red picture element, a green picture element, and a blue picture element;
the backlight includes a red light source, a green light source, and a blue light source;
the aperture ratio converting section decreases an aperture ratio included in image data for the green picture element; and
the backlight luminance control section increases a luminance of the green light source over respective luminances of the red light source and the blue light source.

4. The liquid crystal display device according to claim 1,
wherein:
the backlight has a light-emitting surface that is divided into a plurality of light-emitting regions; and
the backlight luminance control section carries out luminance controls different from one another for the respective divisional light-emitting regions.

5. The liquid crystal display device according to claim 1,
wherein:
the backlight includes light sources having respective colors that correspond to picture elements having a plurality of colors;
the liquid crystal display device further comprises:
a second aperture ratio converting section that, in order to reduce a gray scale difference between the picture elements in a pixel, converts aperture ratios, included in the inputted image data, of said picture elements in the pixel and outputs data of the converted aperture ratios; and
a second backlight luminance control section that, in order to correct the gray scale difference between said picture elements in the pixel which gray scale difference has been reduced by the second aperture ratio converting section, (i) increases, over a luminance of a light source having a color identical to a color of a picture element of which an aperture ratio is not changed by the second aperture ratio converting section, a luminance of a light source having a color identical to a color of a picture element of which an aperture ratio is decreased by the second aperture ratio converting section and (ii) decreases, against the luminance of the light source having the color identical to the color of the picture element of which the aperture ratio is not changed by the second aperture ratio converting section, a luminance of a light source having a color identical to a color of a picture element of which an aperture ratio is increased by the second aperture ratio converting section; and
the liquid crystal display device causes the aperture ratio converting section, the backlight luminance control section, and at least one of the second aperture ratio converting section and the second backlight luminance control section to convert the aperture ratios of the respective picture elements in the liquid crystal panel and control the backlight luminances.

6. A liquid crystal display device, comprising:
a liquid crystal panel including pixels arranged in a matrix; and
a backlight that irradiates the liquid crystal panel with light,
the pixels each including a plurality of picture elements that are different from one another in color,
the picture elements each being provided with a color filter corresponding to a color of the picture element,
the backlight including light sources having respective colors that correspond to picture elements having a plurality of colors,
the liquid crystal display device further comprising:
an aperture ratio converting section that, in order to reduce a gray scale difference between the picture elements in a pixel, converts aperture ratios, included in inputted image data, of said picture elements in the pixel and outputs data of the converted aperture ratios; and
a backlight luminance control section that, in order to correct the gray scale difference between said picture elements in the pixel which gray scale difference has been reduced by the aperture ratio converting section, (i) increases, over a luminance of a light source having a color identical to a color of a picture element of which an aperture ratio is not changed by the aperture ratio converting section, a luminance of a light source having a color identical to a color of a picture element of which an aperture ratio is decreased by the aperture ratio converting section and (ii) decreases, against the luminance of the light source having the color identical to the color of the picture element of which the aperture ratio is not changed by the aperture ratio converting section, a luminance of a light source having a color identical to a color of a picture element of which an aperture ratio is increased by the aperture ratio converting section,
the liquid crystal display device carrying out an intended gray scale display on a basis of (i) backlight luminances determined by the backlight luminance control section and (ii) aperture ratios of the respective picture elements in the liquid crystal panel, said aperture ratios having been obtained through an aperture ratio conversion process by the aperture ratio converting section.

7. The liquid crystal display device according to claim 6,
wherein:
the backlight has a light-emitting surface that is divided into a plurality of light-emitting regions; and
the backlight luminance control section carries out luminance controls different from one another for the respective divisional light-emitting regions.

8. A method for controlling display of a liquid crystal display device including: a liquid crystal panel including pixels arranged in a matrix; and a backlight that irradiates the liquid crystal panel with light, the pixels each including a plurality of picture elements that are different from one another in color, the picture elements each being provided with a color filter corresponding to a color of the picture element,
the method comprising:
an aperture ratio converting step for, in order to reduce light which has a wavelength of a color different from the color of the picture element and which is transmitted through the color filter with which the picture element is provided, decreasing an aperture ratio, included in inputted image data, of a picture element and outputting data of the decreased aperture ratio; and
a backlight luminance control step for, in order to supplement the aperture ratio decreased in the aperture ratio converting step, increasing a backlight luminance as compared to a case in which the aperture ratio is not decreased,
the liquid crystal display device carrying out an intended gray scale display on a basis of (i) backlight luminances determined in the backlight luminance control step and (ii) aperture ratios of the respective picture elements in the liquid crystal panel, said aperture ratios having been obtained through an aperture ratio conversion process in the aperture ratio converting step.

9. A method for controlling display of a liquid crystal display device including: a liquid crystal panel including pixels arranged in a matrix; and a backlight that irradiates the liquid crystal panel with light, the pixels each including a plurality of picture elements that are different from one another in color, the picture elements each being provided with a color filter corresponding to a color of the picture element, the backlight including light sources having respective colors that correspond to picture elements having a plurality of colors,
the method comprising:
an aperture ratio converting step for, in order to reduce a gray scale difference between the picture elements in a pixel, converting aperture ratios of said picture elements in the pixel for inputted image data and outputting data of the converted aperture ratios; and
a backlight luminance control step for, in order to correct the gray scale difference between said picture elements in the pixel which gray scale difference has been reduced in the aperture ratio converting step, (i) increasing, over a luminance of a light source having a color identical to a color of a picture element of which an aperture ratio is not changed in the aperture ratio converting step, a luminance of a light source having a color identical to a color of a picture element of which an aperture ratio is decreased in the aperture ratio converting step and (ii) decreasing, against the luminance of the light source having the color identical to the color of the picture element of which the aperture ratio is not changed in the aperture ratio converting step, a luminance of a light source having a color identical to a color of a picture element of which an aperture ratio is increased in the aperture ratio converting step,
the method causing the liquid crystal display device to carry out an intended gray scale display on a basis of (i) backlight luminances determined in the backlight luminance control step and (ii) aperture ratios of the respective picture elements in the liquid crystal panel, said aperture ratios having been obtained through an aperture ratio conversion process in the aperture ratio converting step.
